(19) United States
(12) Patent Application Publication
(10) Pub. No.: US 2022/0235191 A1
(43) Pub. Date: Jul. 28, 2022

(54) FIBERS, PREPREG MATERIALS, COMPOSITIONS, COMPOSITE ARTICLES, AND METHODS OF PRODUCING COMPOSITE ARTICLES

(71) Applicant: The Trustees of Indiana University, Bloomington, IN (US)

(72) Inventors: Mangilal Agarwal, Carmel, IN (US); Hamid Dalir, Carmel, IN (US)

(21) Appl. No.: 17/622,494

(22) PCT Filed: Jun. 25, 2020
(86) PCT No.: PCT/US2020/039514

§ 371 Date: Dec. 23, 2021

Related U.S. Application Data
(60) Provisional application No. 62/866,319, filed on Jun. 25, 2019.

(51) Int. Cl. C08J 5/24; B29C 70/12; B29B 11/16

(52) U.S. Cl. CPC C08J 5/243; B29C 70/12; B29K 2105/124; C08J 2363/00; B29B 11/16

(57) ABSTRACT

Fibers, prepreg materials, compositions, composite articles, and methods of producing composite articles are disclosed herein. A fiber may include at least one polymeric fiber and a plurality of carbon nanotubes. The at least one polymeric fiber extends in a lengthwise direction. The at least one polymeric fiber is a nanofiber.

### CROSS-REFERENCE TO RELATED APPLICATION

This application claims priority to, and the benefit of, U.S. Provisional Patent Application Ser. No. 62/866,319 entitled “Manufacturing of Submicron Carbon Nanotube-Epoxy Nanocomposite Filaments,” which was filed on Jun. 25, 2019. That provisional application is incorporated herein by reference in its entirety.

### FIELD OF THE DISCLOSURE

The present disclosure relates, generally, to carbon-containing fibers, and, more specifically, to carbon-containing fibers incorporating nanomaterials.

### BACKGROUND

Carbon nanotubes (CNTs) are cylindrical carbon molecules suited for use in a wide variety of applications (e.g., nano-electronics, optics, materials applications, etc.) due to their unique properties. CNTs typically exhibit very high strength and distinctive electrical properties. In addition, CNTs are often efficient conductors of heat. Some carbon-containing nanocomposites, such as epoxy-based nanocomposites, for example, may be particularly well adapted for use in aerospace, automotive, and motorsports applications as a result of their desirable mechanical properties.

Electrospinning is a versatile, inexpensive, and environmentally benign technique for producing continuous fibers having diameters that range from the submicron to the nanometer. Although studies have been performed on epoxy nanocomposite preparation, fabrication of submicron filaments of epoxy nanocomposites by electrospinning has remained relatively elusive. Attempts to fabricate electrospun nanocomposite fibers, such as by thermoset-thermoplastic blending and core-sheath fabrication, for example, may be limited by the presence of thermoplastic materials, which tend to offer reduced mechanical performance at elevated temperatures. In many cases, removal of the sacrificial polymer subsequent to electrospinning with minimal detrimental influence on the mechanical properties of the particular resin has been quite difficult to achieve.

### SUMMARY

The present disclosure may comprise one or more of the following features and combinations thereof.

According to one aspect of the present disclosure, a thermoset resin fiber is disclosed herein.

In some embodiments, the thermoset resin fiber may be a nanofiber, and the thermoset resin fiber may include at least one resin selected from one or more of the following: epoxy amines, polymethylene diisocyanates (PMDI), polyurethane resins, polyimide resins; isocyanate resins; (meth)acrylic resins; phenolic resins; vinylic resins; styrenic resins; polyester resins; melamine resins; vinylester resins; maleimide resins; and mixtures thereof. Additionally, in some embodiments, the thermoset resin fiber may include a plurality of nanotubes, and the plurality of nanotubes may be carbon nanotubes that are aligned in plane with the thermoset fiber. Furthermore, in some embodiments still, the thermoset resin fiber may be produced by electrospinning.

According to another aspect of the present disclosure, a prepreg material may include fibers and at least one polymer material. The material may be coated and/or impregnated with a thermoset resin fiber having a plurality of carbon nanotubes.

In some embodiments, the carbon nanotubes may be aligned in plane with the thermoset resin fiber. Additionally, in some embodiments, the prepreg material may be coated and/or impregnated with the thermoset resin fiber by electrospinning.

According to yet another aspect of the present disclosure, a composition may include a thermoset resin, a plurality of carbon nanotubes, and a polar solvent.

In some embodiments, the composition may include 0.1-100% thermoset resin, 0-10% carbon nanotubes, and the polar solvent. Additionally, in some embodiments, the composition may include at least one of a binder, a curing agent, a hardener, and/or a surfactant.

According to yet another aspect of the present disclosure still, a composite article may include a first prepreg material layer and a second prepreg material layer. The second prepreg material layer may be integrally connected to the first prepreg material layer to form an interface of the first prepreg material layer and the second prepreg material layer. The interface may include a thermoset resin fiber having a plurality of carbon nanotubes.

In some embodiments, the plurality of carbon nanotubes may be aligned in plane with the thermoset resin fiber. Additionally, in some embodiments, the composite article may include a third, a fourth, a fifth, a sixth, a seventh, and an eighth prepreg material layer.

Further, according to one aspect of the present disclosure, a fiber may include at least one polymeric fiber and a plurality of carbon nanotubes. The at least one polymeric fiber may extend in a lengthwise direction. The at least one polymeric fiber may be a nanofiber. The plurality of carbon nanotubes may be aligned with the at least one polymeric fiber in the lengthwise direction.

In some embodiments, the fiber may be an electrospun thermoset resin fiber. The fiber may be an epoxy resin fiber.

In some embodiments, each of the plurality of carbon nanotubes may have a length of from 1400 nanometers to 1800 nanometers. Each of the plurality of carbon nanotubes may have a diameter of from 5 nanometers to 10 nanometers.

Further still, according to another aspect of the present disclosure, a prepreg material may include at least one polymer material and a plurality of reinforcement fibers contained in the at least one polymer material. The prepreg material may be coated and/or impregnated with a polymeric nanofiber that extends in a lengthwise direction and with a plurality of carbon nanotubes that are aligned with the polymeric nanofiber in the lengthwise direction.

In some embodiments, the polymeric nanofiber and the plurality of carbon nanotubes may be included in a thermoset resin fiber. The thermoset resin may be at least one resin selected from the following: epoxy amines, polymethylene diisocyanates (PMDI), polyurethane resins, polyimide resins, isocyanate resins, (meth)acrylic resins, phenolic resins, vinylic resins, styrenic resins, polyester resins, melamine resins, vinylester resins, maleimide resins, and mixtures thereof. Additionally, in some embodiments, the thermoset resin fiber may be an epoxy resin fiber. The plurality of reinforcement fibers may be carbon-containing fibers.

In some embodiments, the prepreg material may be coated and/or impregnated with the polymeric nanofiber and the plurality of carbon nanotubes by electrospinning. Additionally, in some embodiments, each of the plurality of carbon nanotubes may have a length of from 1200 nanometers to 2000 nanometers. Furthermore, in some embodiments still, each of the plurality of carbon nanotubes may have a diameter of from 4 nanometers to 15 nanometers.

According to a further aspect of the present disclosure, a composition may include a thermoset resin, a plurality of carbon nanotubes, and a polar solvent.

In some embodiments, the composition may include at least 0.1% thermoset resin and no more than 10% carbon nanotubes. The thermoset resin may be an epoxy resin. Additionally, in some embodiments, the thermoset resin may be at least one resin selected from the following: epoxy amines, polymethylene diisocyanates (PMDI), polyurethane resins, polyimide resins, isocyanate resins, (meth)acrylic resins, phenolic resins, vinylic resins, styrenic resins, polyester resins, melamine resins, vinylester resins, maleimide resins, and mixtures thereof.

In some embodiments, the polar solvent may be at least one solvent selected from the following: dimethyl sulfoxide (DMSO), dimethylformamide (DMF), acetonitrile, acetone, methyl ethyl ketone, 1,4-Dioxane and tetrahydrofuran (THF), N-methylpyrrolidone, pyridine, piperidine, dimethyl ether, hexamethylphosphorotriamide, dimethylformamide, methyl dodecyl sulfoxide, N-methyl-2-pyrrolidone and 1-methyl-2-pyrrolidinone, and azone (1-dodecylazacycloheptan-2-one). The composition may include a curing agent selected from one of the following: triethylenetetramine, N-hydroxypropyltriethylenetetramine, isophoronediamine, a mixture of equal parts of 2,2,4-trimethylhexamethylenediamine and 2,3,3-trimethylhexamethylenediamine, N,N-diethylpropane-1,3-diamine, N-(2-aminoethyl)piperazine and methyltetrahydrophthalic anhydride.

In some embodiments, the composition may include a surfactant. The composition may include a hardener.

In some embodiments, each of the plurality of carbon nanotubes may have a length of from 1400 nanometers to 1800 nanometers. Additionally, in some embodiments, each of the plurality of carbon nanotubes may have a diameter of from 5 nanometers to 10 nanometers.

According to a further aspect of the present disclosure still, a composite article may include a first material layer and a second material layer. The second material layer may be coupled to the first material layer to form an interface with the first material layer. The interface may include a thermoset resin fiber having a plurality of carbon nanotubes. Each of the plurality of carbon nanotubes may be aligned with, and arranged parallel to, the thermoset resin fiber in a lengthwise direction.

In some embodiments, the plurality of carbon nanotubes may be uniformly dispersed throughout at least 10% of an area of the interface. Additionally, in some embodiments, the thermoset resin fiber may be an epoxy resin fiber. Furthermore, in some embodiments still, the thermoset resin may be at least one resin selected from the following: epoxy amines, polymethylene diisocyanates (PMDI), polyurethane resins, polyimide resins, isocyanate resins, (meth)acrylic resins, phenolic resins, vinylic resins, styrenic resins, polyester resins, melamine resins, vinylester resins, maleimide resins, and mixtures thereof. Further, in some embodiments yet still, the composite article may include a third material layer, a fourth material layer, a fifth material layer, a sixth material layer, a seventh material layer, and an eighth material layer.

In some embodiments, one or more of the plurality of carbon nanotubes may be associated with the first material layer, and the one or more of the plurality of carbon nanotubes may penetrate into at least a portion of the second material layer. One or more of the plurality of carbon nanotubes may be associated with the second material layer, and the one or more of the plurality of carbon nanotubes associated with the second material layer may penetrate into at least a portion of the first material layer.

In some embodiments, each of the plurality of carbon nanotubes may have a length of from 1400 nanometers to 1800 nanometers. Each of the plurality of carbon nanotubes may have a diameter of from 5 nanometers to 10 nanometers.

According to a further aspect of the present disclosure yet still, a method of producing a composite article may include processing a prepreg material including at least one polymer material and a plurality of carbon-containing reinforcement fibers, preparing a nanocomposite solution including a thermoset resin and a plurality of carbon nanotubes, and electrospinning the nanocomposite solution onto each layer of the prepreg material.

In some embodiments, electrospinning the nanocomposite solution onto each layer of the prepreg material may include depositing the nanocomposite solution between layers of the prepreg material. The method may include dispersing the nanocomposite solution in the prepreg material such that the plurality of carbon nanotubes are aligned with one or more layers of the prepreg material and/or the carbon-containing reinforcement fibers.

In some embodiments, the method may include dissipating a solvent of the nanocomposite solution. Additionally, in some embodiments, the thermoset resin may include an epoxy resin. Furthermore, in some embodiments still, the thermoset resin may be at least one resin selected from the following: epoxy amines, polymethylene diisocyanates (PMDI), polyurethane resins, polyimide resins, isocyanate resins, (meth)acrylic resins, phenolic resins, vinylic resins, styrenic resins, polyester resins, melamine resins, vinylester resins, maleimide resins, and mixtures thereof.

In some embodiments, processing the prepreg material may include cutting the prepreg material into eight layers to form a laminate. Cutting the prepreg material into eight layers to form the laminate may include arranging the eight layers in at least one 0/90/45/-45 stacking sequence.

These and other features of the present disclosure will become more apparent from the following description of the illustrative embodiments.

### BRIEF DESCRIPTION OF THE DRAWINGS

The invention described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 illustrates short-beam shear (SBS) test results for a control and reinforced composites incorporating carbon nanotubes;

FIG. 2 illustrates load-displacement curves for a control and reinforced composites incorporating carbon nanotubes;

FIG. 3 illustrates the fabrication of coated prepreg material coupons after deposition of epoxy filaments according to one embodiment of the present disclosure;

FIG. 4 illustrates an electrospinning setup according to one embodiment of the present disclosure;

FIG. 5 illustrates a carbon nanotube dispersion in an epoxy matrix according to one embodiment of the present disclosure;

FIG. 6 illustrates submicron electrospun carbon nanotube-epoxy reinforced filaments according to one embodiment of the present disclosure;

FIG. 7 illustrates the thickness range, uniformity, and unidirectional formation of carbon nanotubes within the polymer structure of carbon nanotube-epoxy reinforced filaments according to one embodiment of the present disclosure;

FIG. 8 illustrates a schematic representation of an enhanced composite, fabrication, and a final product;

FIG. 9 illustrates a specimen configuration and fixture setup for a SBS test;

FIG. 10 illustrates SEM images of (a) electrospun MWCNTs/epoxy nanofiber, (b) control, and (c) enhanced composite;

FIG. 11 illustrates SEM images of the fracture mechanism of (a) control specimens and (b) MWCNTs/epoxy enhanced composite specimens;

FIG. 12 illustrates (a) representative load-displacement curves of specimens under flexural loading and (b) maximum interlaminar shear strength vs. MWCNTs weight fraction;

FIG. 13 illustrates stress-strain curves of enhanced and control composites;

FIG. 14 illustrates (a) 16.50 J impact on a control composite, (b) 16.50 J impact on an enhanced composite, (c) 23.94 J impact on a control composite, and (d) 23.94 J impact on an enhanced composite;

FIG. 15 illustrates thermal conductivity of control and enhanced composites with various contents of MWCNTs;

FIG. 16 illustrates (a) through-plane conductivity measured at 100 Hz and (b) EMI SE of the control and enhanced composites at different content of MWCNTs electrospun nanofibers;

FIG. 17 illustrates a process schematic for making submicron CNT/epoxy filaments through electrospinning;

FIG. 18 illustrates raman spectra of a cured CNT/epoxy and epoxy sample;

FIG. 19 illustrates SEM images of cryofractures in CNT/epoxy samples revealing the formation of CNT rods inside the epoxy structure;

FIG. 20 illustrates XRD analysis of epoxy and CNT/epoxy samples;

FIG. 21 illustrates SEM images of electrospun CNT/epoxy solutions after a) 5 hours, b) 20 hours, and c) 30 hours resting time;

FIG. 22 illustrates X-ray photoelectron spectroscopy spectra of epoxy composites with (a) no CNT, (b) 2% CNT, and c) 4% CNT;

FIG. 23 illustrates submicron filament scaffolds from a) a side view and top view, b) neat epoxy, c) 2 wt. % CNT/epoxy, and d) 4 wt. % CNT/epoxy;

FIG. 24 illustrates the modulus volume fraction relation of the CNT/epoxy nanofiber with different CNT concentrations;

FIG. 25 illustrates thermal analysis of a CNT/epoxy filament; and

FIG. 26 illustrates a) a top view STEM, b) a side view STEM, c) a top view TEM, and d) a side view TEM images of an electrospun CNT/epoxy fiber.

### DETAILED DESCRIPTION

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

A number of features described below may be illustrated in the drawings in phantom. Depiction of certain features in phantom is intended to convey that those features may be hidden or present in one or more embodiments, while not necessarily present in other embodiments. Additionally, in the one or more embodiments in which those features may be present, illustration of the features in phantom is intended to convey that the features may have location(s) and/or position(s) different from the locations(s) and/or position(s) shown.

The present disclosure relates to fabrication of a submicron carbon nanotube-epoxy nanocomposite using electrospinning. As described in greater detail below, the present disclosure enables fabrication of nanocomposite fibers with aligned carbon nanotube reinforcement. As will be apparent from the discussion that follows, a structural epoxy resin carefully mixed with carbon nanotube reinforcements is disclosed herein.

In one respect, the concepts of the present disclosure are related to the disclosure contained in the publication by Hamid Dalir et al. entitled “Enhancing Physical and Mechanical Properties of Carbon Fiber Reinforced Prepregs via Electrospun MWCNTs/Epoxy Nanofiber Scaffolds.” The contents of that publication are incorporated herein by reference in their entirety.

In another respect, the concepts of the present disclosure are related to the disclosure contained in the publication by Hamid Dalir et al. entitled “Electrospun Thermosetting Carbon Nanotube-Epoxy Nanofibers.” The contents of that publication are incorporated herein by reference in their entirety.

In some embodiments, a thermoset resin fiber of the present disclosure may include a plurality of nanomaterials, such as carbon nanotubes, for example. In such embodiments, the thermoset resin fiber may be incorporated into, or otherwise form a portion of, an epoxy resin. Additionally, in such embodiments, the plurality of nanomaterials may include nanowires, nanoparticles, gold nanoparticles, graphene, or other suitable nanomaterials.

In some embodiments, the nanomaterials may be substantially aligned in substantially the same orientation as other nanomaterials (e.g., nanotubes) in the fiber. Additionally, in some embodiments, the nanomaterials may be all carbon nanotubes. In other embodiments, the nanomaterials may include both carbon nanotubes and non-carbon nanotubes.

In some embodiments, the carbon nanotubes may have a length of from about 1200 nanometers to about 2000 nanometers. In some embodiments still, the carbon nanotubes may have a length of from about 1400 nanometers to about 1800 nanometers. In some embodiments yet still, the carbon nanotubes may have a diameter of from about 4 nanometers to about 15 nanometers. Further, in some embodiments, the carbon nanotubes may have a diameter of from about 5 nanometers to about 10 nanometers.

In one aspect, the present disclosure is directed to a prepreg material including fibers and at least one polymer material coated and/or impregnated with a thermoset resin fiber having a plurality of nanomaterials. In some embodiments, the coating and/or impregnation is achieved by electrospinning. Of course, in other embodiments, it should be appreciated that the coating and/or impregnation may be performed by other suitable techniques, such as by spray coating and blade painting, for example.

In another aspect, the present disclosure is directed to a composition including a thermoset resin, carbon nanotubes, and a polar solvent. Exemplary polar solvents include, but are not limited to, dimethyl sulfoxide (DMSO), dimethylformamide (DMF), acetonitrile, acetone, methyl ethyl ketone, 1,4-Dioxane and tetrahydrofuran (THF), N-methylpyrrolidone, pyridine, piperidine, dimethyl ether, hexamethylphosphorotriamide, dimethylformamide, methyl dodecyl sulfoxide, N-methyl-2-pyrrolidone and 1-methyl-2-pyrrolidinone, and azone (1-dodecylazacycloheptan-2-one).

In some embodiments, the composition may include a hardener, a curing agent, and/or a surfactant. Exemplary curing agents include, but are not limited to, triethylenetetramine, N-hydroxypropyltriethylenetetramine, isophoronediamine, a mixture of equal parts of 2,2,4-trimethylhexamethylenediamine and 2,3,3-trimethylhexamethylenediamine, N,N-diethylpropane-1,3-diamine, N-(2-aminoethyl)piperazine and methyltetrahydrophthalic anhydride.

In yet another aspect, the present disclosure is directed to a composite article that has a first material layer and a second material layer integrally connected to the first material layer to form an interface of the material layers. The interface includes a thermoset resin fiber having a plurality of nanomaterials such as carbon nanotubes, for example. The thermoset resin fiber may be fully cured, partially cured, or uncured.

A composition including a carbon nanotube-epoxy nanocomposite was prepared and utilized for the purposes of the present disclosure. Different nanocomposites with different carbon nanotube concentrations were achieved via epoxy resin dilution. The diameter and length of the carbon nanotubes were within the range of 5 to 10 nm and 1.4-1.8 μm, respectively. Nanotube reinforcement was selected to avoid the suspension of the carbon nanotubes and to facilitate the dispersion process. Additionally, a polar solvent was used along with a chemical modifier to aid separation of the carbon nanotubes in the final solution. A curing agent may be used as well.

The present disclosure advantageously provides systems and methods for producing substantially aligned nanostructures that have sufficient length and/or diameter to enhance the properties of a material when arranged on or within the material. It should be appreciated that the nanostructures described herein may be uniformly dispersed within various matrix materials, which may facilitate formation of composite structures having improved mechanical, thermal, electrical, or other properties, among other things. Methods contemplated by the present disclosure may also allow for continuous and scalable production of nanostructures, such as nanotubes, nanowires, nanofibers, and the like, for example, on moving substrates, at least in some cases.

As used herein, the term “nanostructure” refers to an elongated chemical structure having a diameter on the order of nanometers and a length on the order of microns to millimeters, at least in some embodiments. In such embodiments, each nanostructure may have an aspect ratio greater than 10, greater than 100, greater than 1000, or greater than 10,000. In some cases, the nanostructure may have a diameter less than 1 μm, less than 100 nm, less than 50 nm, less than 25 nm, or less than 10 nm. Additionally, in some cases, the nanostructure may have a diameter less than 1 nm. Typically, the nanostructure may have a cylindrical or pseudo-cylindrical shape. In some embodiments, the nanostructure may be a nanotube, such as a carbon nanotube.

Various composite articles disclosed herein include a first material layer and a second material layer integrally connected to the first material layer to form an interface of the material layers. The interface may include a set of nanostructures that are substantially aligned with, and disposed substantially parallel to, the interface of the material layers in a lengthwise direction of the nanostructures. Of course, it should be appreciated that in other embodiments, the nanostructures may have another suitable arrangement relative to the interface of the materials layers.

In some embodiments, the nanostructures may be dispersed uniformly throughout at least 10% of the interface. Additionally, in some embodiments, the nanostructures may be uniformly dispersed throughout at least 20%, at least 30%, at least 40%, at least 50%, at least 60%, at least 70%, at least 80%, at least 90%, at least 95%, or 100% of the interface. In one example, the description of “dispersed uniformly throughout at least 10% of the interface” refers to the substantially uniform arrangement of nanostructures over at least 10% of the area of the interface. That is, in that particular example, the nanostructures are primarily arranged uniformly over at least 10% of the area of the interface, rather than in a heterogeneous arrangement of bundles or pellets.

In some embodiments, the nanostructures of the present disclosure may be arranged such that nanostructures associated with, or otherwise corresponding to, the first material layer may penetrate into at least a portion of the second material layer. Similarly, the nanostructures disclosed herein may be arranged such that the nanostructures associated with, or otherwise corresponding to, the second material layer may penetrate into at least a portion of the first material layer. As a consequence of that arrangement, the interface formed between the first material layer and the second material layer does not form a discrete and/or separate layer from the first and second material layers. Rather, binding between the first material layer and the second material layer at the interface is strengthened by the interpenetration of nanostructures from one or both material layers.

In some embodiments, composite material of the present disclosure may exhibit a higher mechanical strength, interlaminar shear strength, and/or toughness when compared to a similar composite material under substantially identical conditions that lacks the substantially aligned nanostructures disclosed herein. Additionally, in some embodiments, composite material of the present disclosure may exhibit a higher thermal and/or electrical conductivity when compared to a similar composite material under substantially identical conditions that lacks the substantially aligned nanostructures disclosed herein.

In some embodiments, substrates described herein may be prepregs. That is, the substrates may include a polymer material (e.g., a thermoset or thermoplastic polymer) containing embedded, aligned, and/or interlaced (e.g., woven or braided) fibers such as carbon fibers. As used herein, the term “prepreg” refers to one or more layers of thermoset or thermoplastic resin containing embedded fibers, such as fibers of carbon, glass, silicon carbide, and the like, for example.

In some embodiments, thermoset materials contemplated by the present disclosure include epoxy, rubber strengthened epoxy, BMI, PMK-15, polyesters, vinylesters, and the like. Additionally, in some embodiments, thermoplastic materials contemplated by the present disclosure include polyamides, polyimides, polyarylene sulfide, polyetherimide, polyesterimides polyarylenes, polysulfones, polyethersulfones, polyphenylene sulfide, polyetherimide, polypropylene, polyolefins, polyketones, polyetherketones, polyetherketoneketone, polyetheretherketones, polyester, and analogs and mixtures thereof.

In some embodiments, the prepregs disclosed herein includes multiple layers each having fibers that are aligned and/or interlaced (woven or braided), and the prepregs are arranged such the fibers of one or more layers are not aligned with the fibers of other layers. In such embodiments, the arrangement of the fibers of the multiple layers relative to one another may be dictated by directional stiffness requirements of the article to be formed from the prepregs, which may be particular to the production method or technique employed. In some cases, the fibers generally may not be appreciably stretched in a longitudinal or lengthwise direction, and as a result, each layer may not be appreciably stretched in the direction along which its fibers are arranged. Exemplary prepregs include, but are not limited to, TORLON thermoplastic laminate, PEEK (polyether etherketone, Imperial Chemical Industries, PLC, England), PEKK (polyetherketone ketone, DuPont) thermoplastic, T800H/3900-2 thermoset from Toray (Japan), and AS4/3501-6 thermoset from Hercules (Magna, Utah).

The fibers, compositions, and/or composite articles described herein may include one or more binding materials or support materials. The binding or support materials may be polymer materials, fibers, metals, or any other materials described herein. For the purposes of the present disclosure, polymer materials suited for use as binding materials and/or support materials may be any material compatible with the nanostructures disclosed herein.

The compositions of the present disclosure are prepared and electrospun according to generally accepted methods and/or techniques. In general, electrospinning refers to processes by which fibers are deposited on a collection apparatus (e.g., a spool or fabric) in the presence of an electric field. Variations in the material (including density, viscosity, composition, and so forth) used in the electrospinning process, as well as variations in the electric field or other parameters of the electrospinning apparatus, may be used to control or affect the deposition of fibers on the collection apparatus.

In some embodiments, an electrospinning apparatus may include a syringe coupled to a syringe pump or another device configured to expel material from an orifice. A high voltage source may be in communication with the syringe. Material to be electrospun may be discharged from the syringe through operation of the syringe pump and deposited on a collector such as a spool or a fabric. In some embodiments, the collector may be grounded to create an electrostatic potential between the high voltage source (and components in communication therewith) and the collector. Material discharged from the syringe may form fibers that are subsequently deposited on the collector. The fibers may be charged with respect to the grounded collector and thereby attracted to the collector by electrostatic forces.

In one exemplary procedure, the syringe may be loaded with a composition of the present disclosure and the syringe pump may be configured to disburse the material at a constant rate. In one example, the rate may be set at 0.1 ml of material per minute. The syringe may be provided with a metal tip that is connected to the positive lead of the high voltage source. The grounded collector may be placed about 7 inches from the syringe tip. The voltage differential may cause, or otherwise contribute to, disbursement of material (i.e., nanoscale fibers) from the syringe to the collector.

The electrospinning apparatus may be utilized to create a mat of electrospun fibers deposited on a cloth on the collector, at least in some embodiments. In other embodiments, however, the electrospun fibers may be collected on a spool. In any case, the syringe pump may be operated such that the composition loaded in the syringe (or any other fluid contained therein) is forced out of the syringe. In some embodiments, as the composition is expelled from the syringe, the expelled stream or jet of material may elongate to form a relatively small diameter fiber of material. Further, in some embodiments, the expelled material may be electrically charged with respect to the collector and drawn to the collector by electrostatic forces. The electrostatic forces may tend to stretch and/or elongate the material as the fibers begin to form and thereby affect the deposition of the fibers on the collector. Additionally, in some embodiments, the strength of the electrostatic field may be varied in connection with controlling the deposition of fibers on the collector.

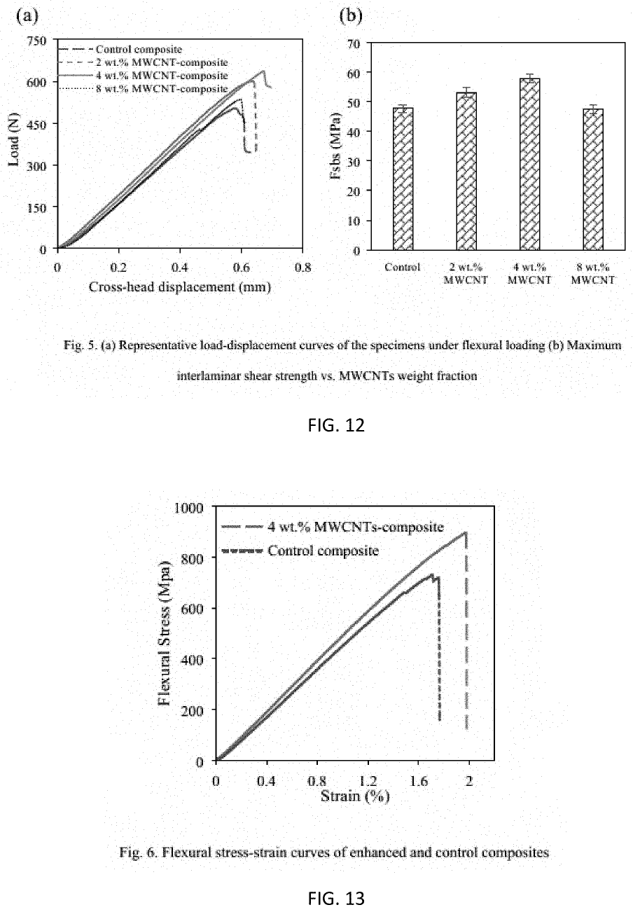

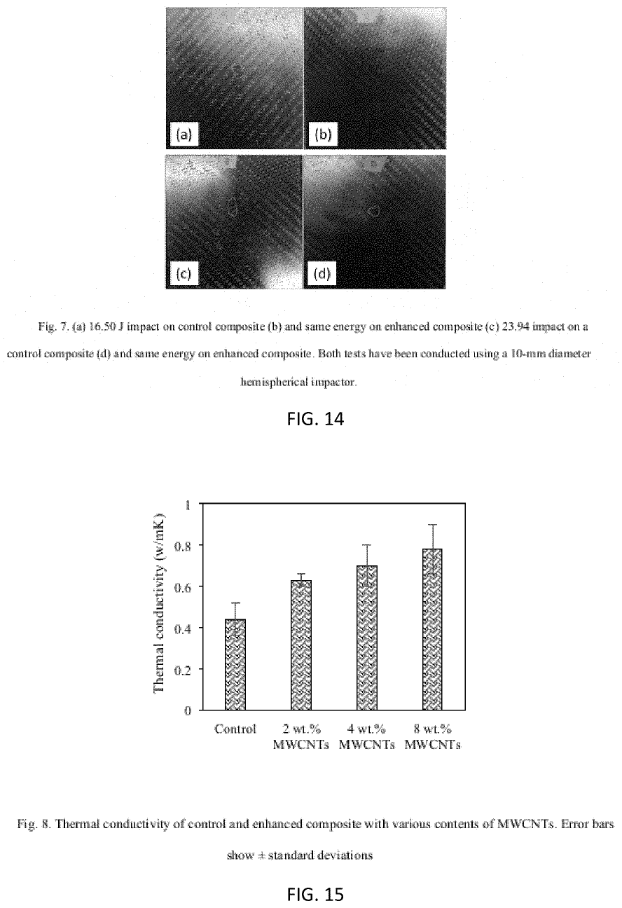

It should be appreciated that during the electrospinning process, certain components of the compositions disclosed herein (e.g., solvents) may partially or fully evaporate as fibers form from the material expelled from the syringe. Thus, the fibers eventually formed during the electrospinning process contact, and are deposited on, the collector. As shown in FIG. 5, for example, the carbon nanotubes are well dispersed in the nanocomposite base/epoxy matrix. The submicron reinforced electrospun nanocomposite fibers are illustrated in FIG. 6.

The present disclosure provides a practical method to enhance the interlaminar shear strength of a pre-impregnated or pre-preg composite by depositing a thin layer of electrospun epoxy or reinforced epoxy fibers in between layers or portions of the composite. That arrangement may facilitate, or otherwise be associated with, a more efficient mechanical strength increase than that achieved by other configurations due to a large volume to surface ratio with porosity. In addition, that arrangement may form, or otherwise be associated with, interlayer bonding to achieve enhanced short beam shear strength and an interfacial toughening effect. It should be appreciated that in some configurations, nanoscale, ultra-fine fibers may be directly produced by electrospinning thermoplastic polymer solutions such as polyvinylpyrrolidone (PVP), polyvinyl alcohol (PVA), and polycaprolactone (PCL), for example. However, the submicron size fibers contemplated by the present disclosure may be electrospun thermosetting epoxy polymers. According to the present disclosure, at least in some embodiments, increasing the spinnability of a thermosetting polymer may enable production of a unique nanofiber.

The production of epoxy nanocomposite fibers according to the present disclosure may provide fibers, pre-preg materials, compositions, and composite articles that exhibit desirable mechanical and thermal properties and are thereby suited for use in a wide range of structural applications. Due at least in part to the dispersal and alignment/orientation of reinforcements such as carbon nanotubes or any other nanomaterials, for example, the composites of the present disclosure may provide a large surface area and be compatible for use with, or inclusion in, epoxy matrices in relatively advanced composite applications. It should be appreciated that due at least in part to the absence of a co-polymer or solvent residue in the resulting electrospun fiber, an advancement in mechanical properties of the resulting fiber may be reliably ensured.

To evaluate the potential of the reinforced electrospun CNT-based epoxy nanomaterial composites disclosed herein for industrial applications, dispersion following electrospinning the CNT-based epoxy nanocomposite and simultaneously deposition on pre-impregnated composite plies (pre-preg) was performed. The methodology leads to, or is otherwise associated with, alignment of CNT with the pre-preg fibers to improve the interlaminar shear strength of carbon fiber reinforced polymers (CFRP). The resulting CNT-based epoxy nanofibers achieve improved mechanical characteristics in a simple and cost effective manner. The CNT dispersion and nanofiber production through the electrospinning method described herein may be easily scalable to the industrial level.

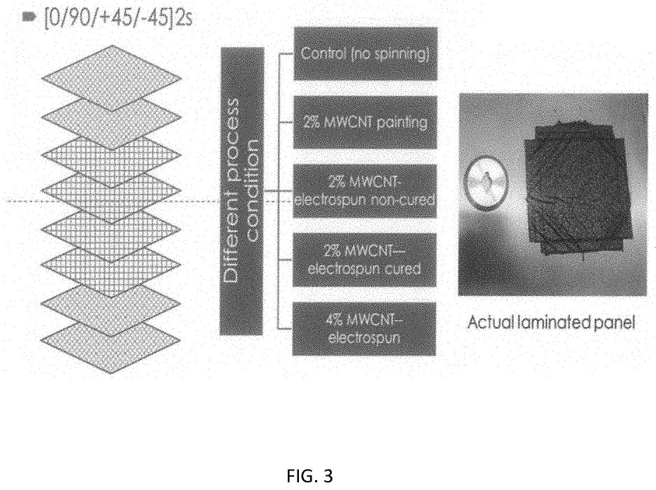

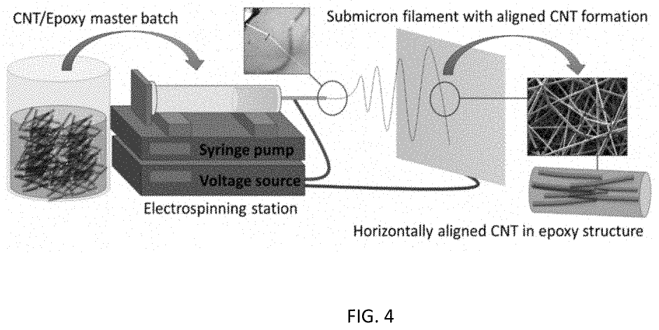

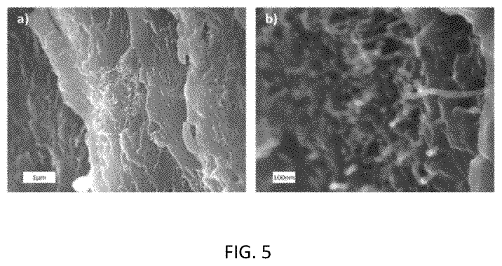

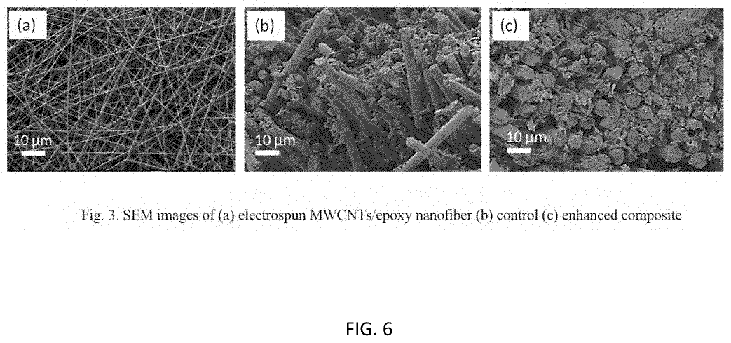

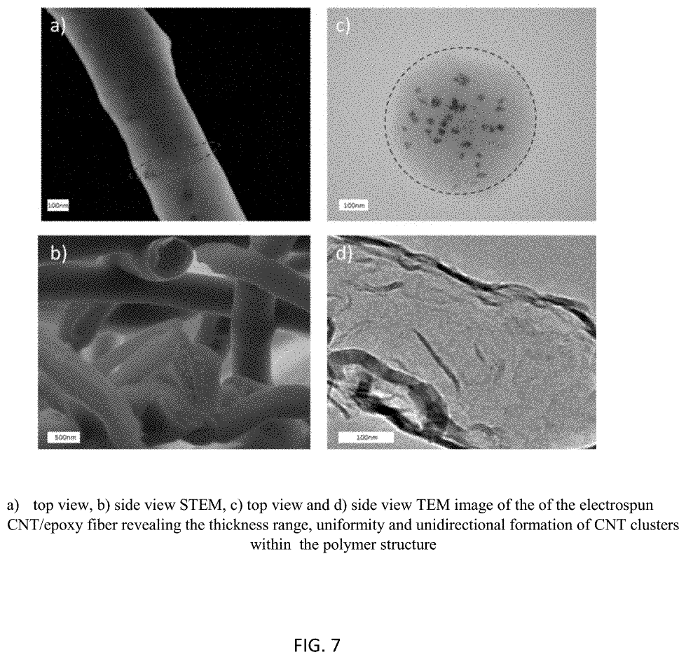

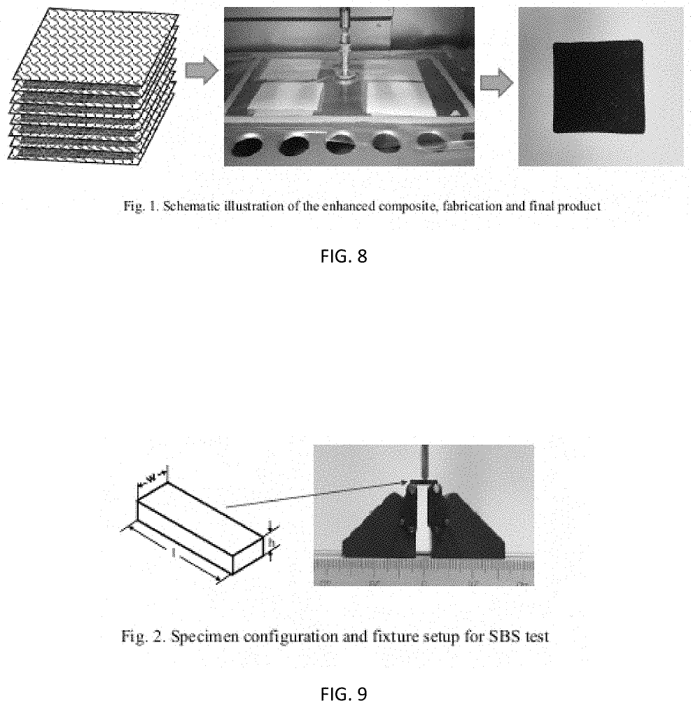

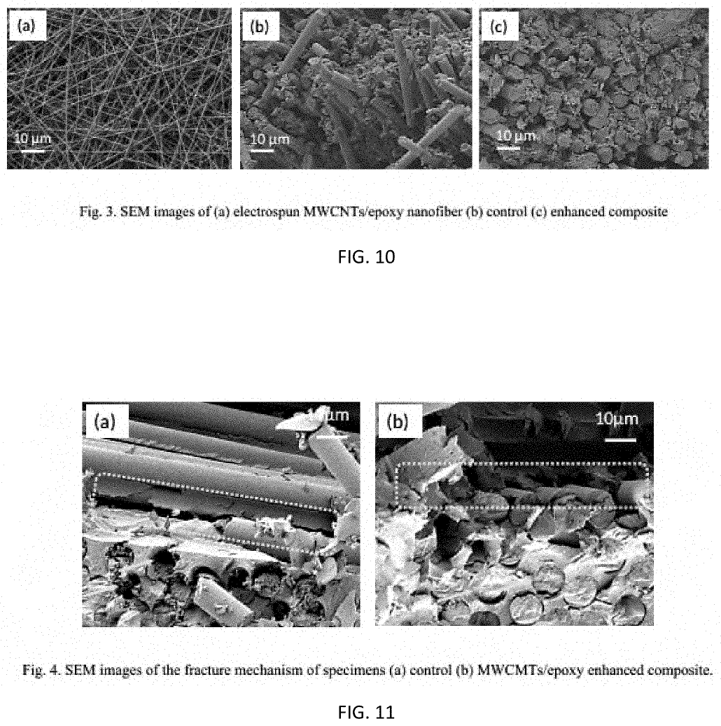

According to one methodology contemplated by the present disclosure, prior to electrospinning, a woven fabric prepreg composite was cut into 8 layers to provide a laminate with a (0/90/45/-45) stacking sequence. The woven prepreg composite, the 8 layers thereof, and the stacking sequence are depicted in FIG. 3. Thereafter, the prepared nanocomposite solution was added to a glass syringe and electrospun onto each layer with a reference thickness. An exemplary setup for performing the electrospinning process is depicted in FIG. 4. The composite laminate containing electrospun nanocomposite layers was cured in a vacuum oven before characterization.

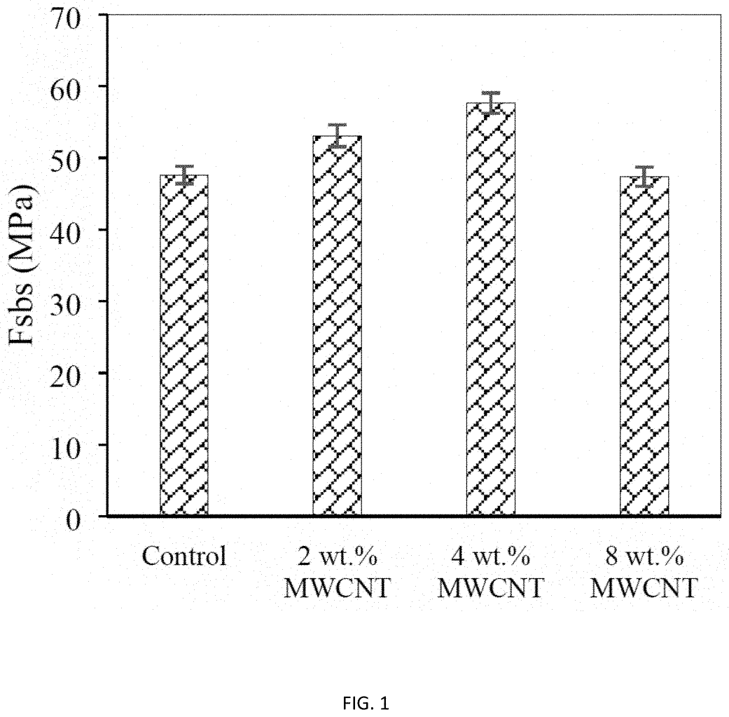

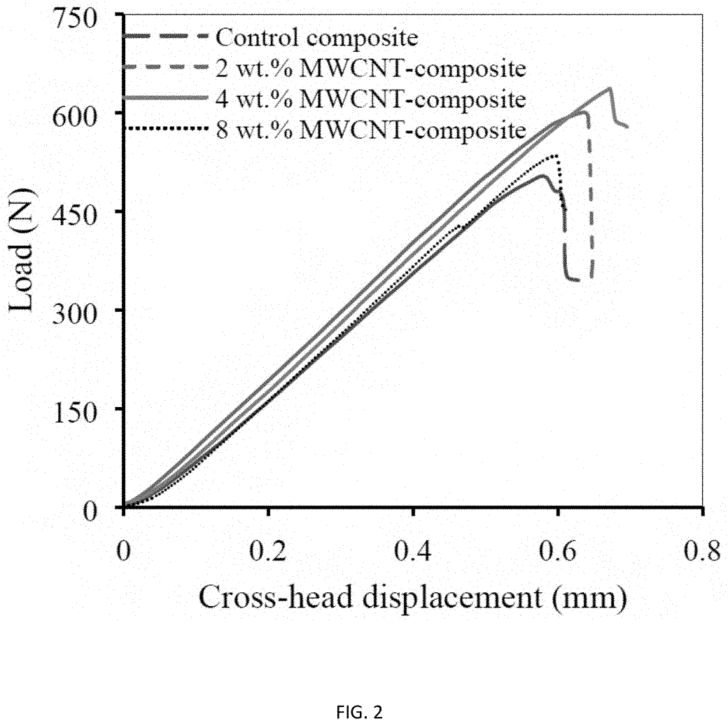

As part of the characterization process, short beam shear (SBS) tests were conducted using ASTM D2344 to calculate the interlaminar shear strength (F) by F=0.75×(P/(b×h)) where P, b, and h are the maximum load, the specimen width, and the specimen thickness, respectively. FIG. 1 illustrates that the mechanical properties of the epoxy infused carbon fibers have been improved over 20%. FIG. 2 illustrates the load-extension curves for short beam shear specimens with different CNT (carbon nanotube) concentrations. In this case, a micron layer scaffold of CNT-epoxy (2% and 4% CNT) was deposited between each layer of prepreg followed by standard vacuum bagging and applying relevant cure cycles. These nanocomposite layers improve the mechanical properties of the CFRP substantially without changing the thickness of the CFRP.

As shown in FIG. 1, FIG. 2, and Table 1, adding a layer of electrospun nanocomposites in between composite prepreg layers improves the static and fatigue results by more than 20% and 2-30×, respectively. Table 1 below illustrates the fatigue results improvement for the SBS test.

TABLE 1

| Percentage of | | | |
|---|---|---|---|
| Ultimate Strength | Control | 2% not cured | 2% cured |
| 100% | 1 | 100 | 77 |
| 90% | 26 | 412 | 308 |
| 80% | 1,587 | 6,242 | 4,845 |
| 70% | 2,827 | 22,187 | 16,592 |
| 60% | 64,052 | 121,431 | 91,672 |

A novel cost-effective approach to improve the physical and mechanical properties of the carbon fiber reinforced polymer (CFRP) prepreg composites, where electrospun multiwalled carbon nanotubes (MWCNTs)/epoxy nanofibers synthesized and incorporated in between the layers of conventional CFRP prepreg composite, has been presented. For the first time, MWCNTs aligned epoxy nanofibers were successfully produced by an optimized electrospinning process. These nanofibers were deposited directly onto prepreg layers to achieve improved adhesion and interfacial bonding for added strength. Results revealed that by incorporating these nanofiber scaffolds, mechanical properties of the CFRP prepreg is considerably improved, such that, interlaminar shear strength (ILSS) and fatigue performance at 60% of ultimate strength increased by 21% and 47%, respectively. Moreover, barely visible impact damage (BVID) energy increased significantly by up to 45%. The thermal and electrical conductivities were also enhanced significantly due to the presence of highly conductive MWCNT pathways between CFRP layers. MWCNTs with aligned epoxy nanofibers can seamlessly integrate with CFRPs providing the highest reported interlaminar shear strength making their applications in critical components and opening the potential for new structural applications.

CFRP composites have been used as key materials for structural components in the aerospace, wind energy, automotive, and marine industries [1]. CFRP materials are designed to achieve high strengths, superior thermomechanical, and electrical properties, which cannot be obtained by traditional materials [2,3]. CFRPs are becoming increasingly popular high performance polymer composites due to their versatility with other materials, including metallic fillers [4], ceramics [5], carbon nanotubes (CNTs) [6,7], adhesives [8], and woods [9]. They are broadly employed in many competitive fields due to high specific strength, toughness, excellent corrosion resistance, and fatigue performance [10-13].

While CFRPs demonstrate outstanding in-plane mechanical properties, the out of plane properties such as interlaminar shear strength and toughness are predominantly lower. In fact, lack of fiber reinforcement along the ply thickness causes the matrix properties to dictate the out of plane mechanical performance and make CFRPs very vulnerable through their thickness [14,15]. The layer-by-layer nature of the composite laminates make them susceptible to delamination due to microcrack initiation and prorogation between the plies. Furthermore, damages due to bending and shear loads can be difficult to detect, causing proliferating catastrophic failure under loading. This deficiency limits the employment of CFRP in critical applications such as those in aircraft materials [16].

To enhance the mechanical properties of CFRPs through their thickness [8,17-19], several studies have sought to overcome this inadequacy with bolted or adhesively bonded joints. These research contributions have shown that the use of fasteners and adhesion enhancements are capable of capturing higher through the thickness material properties. However, all these techniques have disadvantages such as noticeable mass increase, crack initiation and high stress concentration in the adhesive layer [20,21].

Research has been conducted to improve the mechanical properties of CFRP through the addition of nanomaterials such as carbon nanotubes [22-25], graphene oxide [26,27], graphite [28], inorganic fillers [29,30] or by modifying the fabrication processes [31] to increase the out of plane properties. For instance, Wang et al. [32] used functionalized CNTs mixed with epoxy resin to manufacture a hybrid composite through resin transfer molding (RTM). Results exhibited improvement in flexural strength and ILSS at very low CNT concentrations (0.05 wt. %), however, by increasing CNT content, ILSS and flexural strength of the composites decreases due to dispersion problems and interfacial adhesion. In another study conducted by Yao et al. [33], a multiscale composite was prepared by mixing two thermoplastic materials with grafted vapor grown carbon nanofibers (VGCNFs) and MWCNTs. The resulting mixture was diluted in ethanol and spray coated onto the fabric layer. The final product showed improvement in ILSS and flexural strength. However, there was no data provided on the fatigue performance. Conway et al. [34] used chemical vapor deposition (CVD) to fabricate vertically aligned carbon nanotubes (VACNTs), which were placed between aerospace grade prepreg plies with different lay-up. The composite was tested, and result showed ˜15% improvement in ILSS.

While these methods show improvements in the mechanical properties of resulting CFRPs, the fabrication complexity is still a challenge. The nanomaterial loadings should remain low to decrease process complexity such as mixing, functionalization, and dispersion, which cause not taking full advantage of superior properties of nanomaterials such as thermal and electrical conductivity. The scale-up requirements of these material enhancement techniques make them ill-suited for industrial use as they are time-consuming and expensive.

Alternatively, to improve the mechanical properties of the CFRPs, applying the small diameter electrospun fiber reinforcement at the interface was a novel concept introduced by Dzenis and Reneker [35]. They used electrospinning, a method widely recognized as the best approach to achieve continuous uniform nanofibers in a single step process [36], to fabricate the reinforcements between the layers. As most of the thermoset resins, such as epoxy, have a very low spinnability, they need to be mixed with a thermoplastic polymer to be suited for the electrospinning process. Lately, electrospun nanofibers using thermoset/thermoplastic techniques have been studied. Electrospun thermoplastics based on polyamide (PA-6,6) polysulfone (PSU) and polyetherimide (PEI) along with a commercial epoxy resin have been directly deposited on prepregs to increase interlaminar fracture toughness [37]. Although this method improved the mechanical properties, the reinforcement layer can deteriorate with the increase of temperature. Another modified method is a technique called coaxial electrospinning permits non-electro spinnable resin to be drawn by a thermoplastic polymer. This is a customized setup based on a conventional electrospinning method where double extruders are used instead of one; the thermoplastic material is treated as the shell, and the thermoset resin is used for the core [38]. This method was used to fabricate shape memorizing microfibers. These resulting polycaprolactone (PCL)/epoxy composite fiber membranes showed an increased storage modulus compared to PCL alone [39,40], as determined through dynamic mechanical analysis. Neisiany et al. [41] also employed an electrospinning method to improve the mechanical properties of carbon/epoxy composite. The enforcement has been made by the deposition of the electrospun polyacrylonitrile (PAN) and electrospun polyacrylonitrile grafted glycidyl methacrylate (PAN-g-GMA), nanofibers between composite layers. Their results showed an 8% improvement in tensile strength and a 6% increase in short beam shear strength for PAN-g-GMA compared to pure PAN. However, the presence of thermoplastic materials in epoxy nanocomposites can deteriorate mechanical properties due to their incompatibility over time [42,43]. Most of the current methods of increasing the fracture toughness using electrospinning involve the incorporation of at least a component with lower shear modulus compared to the matrix, which causes decreasing the average shear modulus of the composite and the final product, deteriorate fiber-matrix interfacial bonding results in delamination, and reduce fatigue life.

To the best of the inventors' knowledge, there is no research on applying electrospun MWCNTs/epoxy nanofiber scaffolds for the improvement of interlaminar shear strength and fatigue life of CFRP. This research demonstrates a new method to fabricate the nanomaterial matrix, made of MWCNTs and epoxy, through electrospinning process for CFRP applications without any thermoplastic additives. The deposition of a thin layer of electrospun MWCNTs/epoxy fiber scaffolds between the prepreg layers, instead of the common direct insertion, preserves the interlaminar thickness. This limits the amount of added materials and make the possibility to produce a unidirectional layer of MWCNT between layers of CFRP. As a result, mechanical properties, including interlaminar shear strength, flexural and tensile properties, fatigue, and barely visible impact damage (BVID) improved. Thermal, electrical conductivity, and electromagnetic interference shielding (EMI) of the fabricated composites were evaluated. Finally, an analytical model based on modified classical laminate theory was proposed to further understanding of the enhancement mechanisms.

A high concentration masterbatch of MWCNTs/epoxy made by shear mixing was diluted with neat epoxy (Miller-Stephenson, USA) in the presence of dimethylformamide (DMF) and surfactant to obtain 2, 4 and 8 wt. % CNT content. To achieve a well-dispersed CNT polymer matrix, probe sonication was applied in steady time intervals. A curing agent was then added to the solution allowing it to rest for 20 hours to create a semi-cured solution with the viscosity required for the electrospinning process. The solution was then degassed in a vacuum oven to remove all the trapped air bubbles. Syringes were filled with the final nanocomposite solution, and electrospinning was performed. The electrospinning process was optimized at 16 kV with the feeding rate, and needle gauge of 0.5 ml/h and 26 G, respectively. A stainless steel collector was placed at a distance of 10 cm from the needle. The solution from the needle tip was deposited on a prepreg layer mounted on the metallic collector resulting in a formation of uniformly deposited MWCTs/epoxy nanofiber scaffold.

The control and enhanced CFRP specimens for testing were fabricated from a hot melt epoxy-carbon fiber with a plain weave pattern (Gurit Holding AG, Wattwil/Switzerland). Here, symmetric and balanced laminate (100×100 mm²) stacks were made using a hand layup method followed by vacuum bagging to minimize void percentage within the [0/90/±45]2 s stacking sequence in cure. For enhanced composites, MWCNTs/epoxy nanofibers were deposited on the CF layers using the previously described optimized electrospinning method. The final panel contained 8 layers of woven fabric and 7 layers of epoxy-MWCNTs nanofibers. The control and enhanced composites were fully cured by placing them in a programmable oven (Easy Composite, UK) at 120° C. for 25 min while vacuuming under 1 bar. The samples were cooled down to room temperature while maintaining the pressure. The specimen's thickness was measured to be 2 mm for all conditions. FIG. 8 shows the fabrication process.

Morphology and structure of nanofibers and composites: The morphology of electrospun MWCNTs/epoxy nanofibers, as well as the interfacial structure on fractured composites, was observed by a field emission scanning electron microscopy (FESEM); (JEOL 7800F, JEOL Japan). Samples were sputtered with a thin layer of gold and imaged at 5 kV.

Mechanical properties: The tensile test was performed according to ASTM D3039 constant head speed rate of 2 mm/min [44]. A three-point bending test was conducted according to ASTM D790-10 standard with a span-to-depth ratio of 40 to ensure that the specimens failed due to flexural loading [45] and a crosshead speed of 1.0 mm/min. Flexural strength and modulus were calculated by [46]:

$$\begin{matrix}{ }^{σ} f = \frac{3 PL}{2 {bd}^{2}} [ 1 + 6 {( \frac{D}{L} )}^{2} - 4 ( \frac{d}{L} ) ( \frac{D}{L} ) ] and \\ & ( 1 ) \\ { }^{E} f = \frac{{mL}^{3}}{4 {bd}^{3}} & ( 2 )\end{matrix}$$

where, P, L, b and, d are the maximum load on the flexural load-displacement curve, support span (mm), width (mm), and thickness of beam (mm), respectively. Note that D is the beam maximum deflection (mm), and m is the slope of the initial straight-line of the load-displacement curve (N/mm).

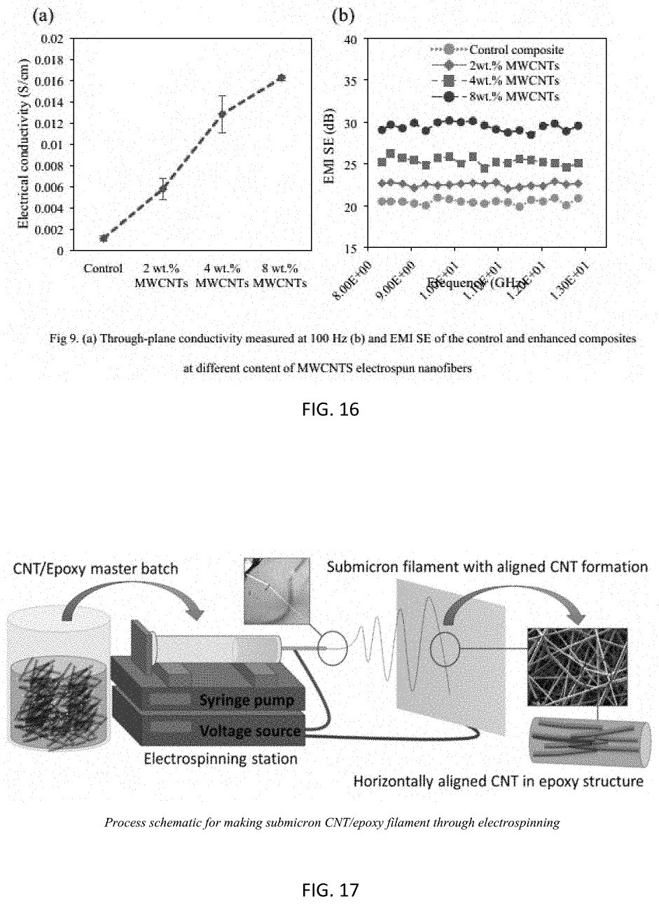

The short beam shear strength test was conducted to estimate the effect of the electrospun MWCNTs/epoxy nanofibers on ILSS of the laminated composite. Specimens were trimmed according to the ASTM 2344D/M standard; a schematic is depicted in FIG. 9. All samples had the same nominal dimension (2×4×12 mm h×w×l) with a tolerance of 0.01 mm. Tests were performed on a universal test machine frame (TestResources, Inc USA) at room temperature. The instrument was equipped with a 2.2 kN load cell, and a cross-head speed of 1.27 mm/min was applied. The span ratio was set to 4. Samples were loaded until fracture occurred, and at least ten repetitions were done for each condition. Using the recorded load and specimen dimensions, short beam shear strengths were calculated [47].

$${F}^{sbs} = 0.75 \times \frac{{P}_{m}}{b \times h} \qquad ( 3 )$$

where F^{sbs} is the short-beam shear strength of the specimen (MPa), Pₘ is the maximum load (N), and b and h are the measured width and thickness (mm) of the specimen, respectively.

The short beam fatigue testing experiment was performed using the same instrument as the short beam shear strength test. Fatigue testing was conducted by cyclic loading of a specimen below static failure load at 60, 70, 80, 90, and 100% of the ultimate load to determine the number of cycles to failure. The maximum ultimate load value was obtained by the short beam shear strength analysis.

Barely visible impact damage (BVID) tests were carried out by a customized aluminum impactor bar with a spherical diameter of 10 mm, and having a weight, length, and width of 325 g, 72.39 cm, and 1.27 cm, respectively. Variable nitrogen gas (N₂) pressures were used to apply force on the impactor. Specimens were fixed on a stand where a high-speed DSC-RX10 camera was used to record images, impactor displacement, and time per revolution. The tip of the impactor was marked red so that the very first displacement of the impactor could be easily detected. Recorded images were analyzed using Image-J software. The impact energy relationship per dent was applied to the control and enhanced CFRP and was calculated using the energy equation.

Thermal conductivity: Testing was performed using a Hot disk analyzer, a ThermTest TPS 500S, A Kaptan 6 mm sensor was used as a heat source and resistance thermometer. Two samples of the same material were sandwiched with the sensor in between. They were operated at 5 milliwatts (mW) for 5 seconds (s); five tests were conducted per sample set.

Electrical conductivity: The electrical conductivity of the samples was measured using a Hewlett Packard 4192A LF impedance analyzer (Hewlett Packard, Palo Alto, Calif., USA) with a 16451B test fixture over the frequency range of 5 Hz to 13 MHz. Before analysis, the top and bottom surfaces of the composite specimens were coated with a conductive silver paste to minimize the surface resistivity. Electrical conductivity, σ, was calculated by [48]:

$$σ = \frac{th}{( A \cdot Z \cdot cos θ )} \qquad ( 4 )$$

where h is the thickness of the sample and A, Z and θ represent the area of the fixture probe, impedance, and the phase angle of the sample.

EMI shielding characterization was conducted according to a waveguide method [49]. The test was performed using an 8719D Keysight network analyzer over the X-band frequency range (8.2-12.4 GHz) [50]. EMI shielding effectiveness (EMI SE) was calculated using the complex scattering parameters (S₁₁, S₁₂, S₂₁, and S₂₂) that correspond to the transmission and reflection of the incident electromagnetic waves.

FIG. 10a exhibits SEM images of the fabricated MWCNTs/epoxy nanofibers using electrospinning over the prepreg layer. The deposited nanofiber scaffold provides a highly porous structure where the thickness of nanofibers can be adjusted using electrospinning parameters such as voltage and collector distance. Nanofibers with a diameter of 100 to 500 nm were produced and randomly deposited. Since the thickness of nanofiber layers significantly affects the mechanical properties of the final product by decreasing the diffusion of epoxy resin through the nanofiber scaffolds in the cure process [51], to avoid that, the thickness of electrospun layers was set to be 10 μm. FIGS. 10(b) and 10(c) show the fracture cross-section of control and enhanced composites. As shown, significant fiber pull-out was observed in the control composite such that epoxy resin detached from carbon fibers suggesting poor adhesion between fibers and matrix. In contrast, enhanced composite using nanofiber scaffolds showed different microstructure with less pull-out, and better embedding of carbon fiber in epoxy resin caused almost single plane failure due to more robust interfacial bonding.

FIG. 11a shows the fracture mechanisms in the control composite. It is observed that the fracture mechanisms are matrix breakage and fiber pull-out, which have been shown by yellow dash lines and arrows. Debonding between fiber and matrix and matrix breakage can be attributed to the poor interfacial adhesion. Considering FIG. 11b for enhanced composite reveals that by adding an electrospun layer, the interfacial bonding between the prepreg layers is improved. Since the nanofibers are made out of the same epoxy, which was used in prepreg layers, the electrospun layer has great adhesion to the prepreg's surface and later, inter-diffuses to prepreg structure during composite fabrication. Therefore, a load can effectively transfer through the layers resulting in higher load-bearing capability by fibers due to less mismatched properties of fiber and matrix. As it is observed in SEM images, more fiber breakage happens in the enhanced composite due to the reduction of local stress concentration. Furthermore, an additional energy consumption mechanism is developed by the electrospun MWCNTs layer causing it to fail in higher loads.

To investigate the influence of electrospun nanofibers on the interlaminar shear strength of enhanced composites, short beam shear strength testing was performed. FIG. 12a represents the load-displacement curves of both control and reinforced composites with electrospun MWCNTs nanofibers. It was observed that load values increased linearly to a maximum level within the elastic region. The incorporation of MWCNTs/epoxy nanofibers between the prepreg plies resulted in an enhancement of load-bearing and strength by using up to 4 wt. % MWCNTs. At 8 wt. % MWCNTs, a sudden drop was observed, which can be attributed to the aggregation of MWCNTs and internal defects due to the high concentration of MWCNTs. The maximum loads increased by 19% and 22% for 2 and 4 wt. % electrospun MWCNTs/epoxy nanofiber composites, respectively (while at 8 wt. %, a 5% decrease was observed). The lower performance for 8 wt. % MWCNTs can be due to local agglomeration of MWCNTs inside nanofibers, which can generate stress concentrations when a load is applied. Moreover, the agglomeration of MWCNTs prevents the proper diffusion of epoxy into the interfacial layer during the cure process, and therefore it might be some regions that remain unfilled with epoxy and voids may be formed.

FIG. 12b displays short beam strength values obtained for different MWCNTs content. Following the trend for load, the maximum value was obtained by 4 wt. % MWCNTs. The noticeable drop was observed for 8 wt. % samples due to the presence of porosities and MWCNTs aggregation as it was described before. There is an 11 and 21% increase in interlaminar shear strength for 2 and 4 wt. % electrospun MWCNTs-epoxy, respectively, and a 0.4% decrease for 8 wt. %

The nanoparticles could block the movement of the polymer chains and consequently increase the shear yield stress of the matrix. Such that, the mobility limitation of the polymer chains creates better interfacial bonding and stress transferring through the layers. It has been suggested that the presence of nanofiber scaffolds could reduce the microcrack propagation in the epoxy matrix due to reinforcement by MWCNTs.

As the main focus of this research was to improve the interlaminar shear strength, according to the short beam shear test results, 4 wt. % MWCNTs/enhanced composite was selected for further mechanical testing. The tensile test was conducted on control and enhanced composites, and the initial slope of the stress-strain curves was used to calculate the tensile modulus. The average values for tensile strength and modulus for control and enhanced composites were found to be 670±12, 735±18 MPa and 33.2±1.2, 39.6±0.9 GPa, respectively. This shows ˜9.7 and 19.2% improvements in tensile strength and modulus by adding 4 wt. % MWCNTs nanofiber scaffolds between prepreg layers.

FIG. 13 shows flexural stress-strain curves for control and enhanced composites. The results revealed that employing the electrospun nanofiber scaffolds generates higher stiffness and failure strength. The values of flexural strength were 748.76±23.83 and 886.18±12.99 MPa and flexural moduli were calculated to be 48.09±0.56 and 43.44±0.34 for enhanced and control composites with the enhancement of ˜17.1 and 10.7%, respectively.

It should be noted that flexural properties govern by volume fraction of reinforcing fibers; however, in this case, since the MWCNTs nanofiber scaffold is compatible with prepreg material as both are thermosetting epoxy polymer, diffusion and impregnation of the nano-scaffold into prepreg layer cause increasing of the flexural properties. Moreover, high porosity and large specific area of electrospun nanofiber scaffold create better interfacial bonding, which helps to dissipate strain energy and prevents composite failure.

Fatigue test results are presented in Table 2. Failure resistance increased up to 100% at the maximum baseline load by adding 4 wt. % electrospun MWCNTs. Moreover, life cycles increased 4× at 90% of the load. The results suggest that the stable growth of microcracks occurs at a lower rate in the presence of MWCNTs at interfaces.

TABLE 2

| Percentage of | Control | 4 wt. % |
|---|---|---|
| ultimate strength | composite | MWCNTs/composite |
| 100% | 1 | 100 |
| 90% | 26 | 412 |
| 80% | 1587 | 6242 |
| 70% | 2827 | 22187 |
| 60% | 64052 | 121431 |

Minor damages are mostly hard to identify on the surface of composites. The formation of those damages on the structures throughout the time can have significant structural impacts such as delamination, matrix cracking, and fiber fracture. To minimize these effects, such damages need to be examined using BVID test to avoid catastrophic failure.

According to the definition, BVID damages are classified as those which are visible at a distance of fewer than 1.5 m, and Visible Impact Damage (VID) are those which visible at a distance of 1.5 m [52]. The impact effect at specific energy rates on control and enhanced composites were presented in FIG. 14. The damaged areas were measured, and results revealed a significant improvement in damage resistance by employing electrospun nanofibers between the prepreg layers of composite. Such that, there is a 7.44 J increase in impact energy absorption by adding 4% MWCNTs/epoxy nanofibers.

It can be concluded that resistance to delamination elevated by ˜45% in energy absorption on the surface, comparing enhanced composites to control ones due to the presence of nano-reinforcement between the prepreg layers, which can dissipate the impact energy. At the energy level of 35.15 J, surface indentation is easily visible, and enhanced composite enters the VID criteria.

Results for thermal conductivity of control and enhanced composites are reported in FIG. 15. It was observed that by incorporating of electrospun MWCNTs/epoxy nanofibers in the composite structure, the thermal conductivity had been increased. Moreover, the thermal conductivity of the fabricated composite was continuously improved by increasing MWCNTs content up to 8 wt. %.

Table 3 summarizes thermal conductivity values and the improvement percentages of enhanced composites in comparison to control samples with no MWCNTs. The thermal conductivity was measured perpendicular to the microfiber the improvement of this direction can be attributed to the inherent superior thermal conductivity of MWCNTs employed in nanofibers, which generates elevated head flow across the thickness. Moreover, The MWCNTs can create bridges between conductive fibers and form a conductive path through the thickness of the CPRF.

TABLE 3

| | Thermal conductivity | |
|---|---|---|
| Samples | Average ± SD (W/m · K) | Increase (%) |
| Control composite | 0.44 ± 0.08 | — |
| 2 wt. % MWCNTs composite | 0.63 ± 0.03 | 4.3 |
| 4 wt. % MWCNTs composite | 0.7 ± 0.1 | 5.9 |
| 8 wt. % MWCNTs composite | 0.78 ± 0.12 | 7.7 |

The minimum thermal conductivity (0.44±0.08 W/m·K) was obtained for control composite while the 8 wt. % electrospun MWCTs/epoxy composite has a measured value of 0.78±0.12 W/m·K, 8% higher compared to control composite.

FIG. 16a demonstrates electrical conductivity at 100 Hz for control and enhanced composites. The values of electrical conductivity of the control, 2, 4, and 8 wt. % MWCNTs composites were determined to be 0.0011±0.0002, 0.0058±0.0009, 0.0120±0.0028, 0.0163±0.0002 S/cm, respectively. It has been observed that electrical conductivity rises by increasing MWCNTs percentage in the interlayer structure due to the creation of additional electrical pathways in between the CF layers and can be explained by percolation, which was reached inside of nanofibers providing a conductive network. The electrical conductivity increased by 4.1, 9.7, and 13.5% with the embedding of 2, 4, and 8 wt. % electrospun nanofiber, respectively. This is an important property as higher electrical conductivity reduces the damage caused by lightning, especially in aircraft, by helping to charge dispersion on the surface [53-55].

FIG. 16b depicts the SE results for the control and different MWCNTs electrospun content. It has been shown that the SE value is independent of the frequency in X-band range, and with increasing the MWCNTs content, the EMI SE increased. EMI shielding effectiveness of the composite is governed by several factors containing conductivity, aspect ratio, and content of the conductive fillers [56,57]. The high electrical conductivity, large surface area, and large aspect ratio of CNTs make them pioneer candidates for EMI shielding applications [58,59]; however, dispersion and distribution of these conductive fillers play a crucial role to obtain desirable results. As was previously reported, increasing EMI effectiveness can be related to the electrical conductivity of specimens [60] such that as it is shown in FIG. 16a, the electrical conductivity of specimens increased by increasing in MWCNTs content, and shielding effectiveness increased continuously with increasing electrical conductivity.

The total effectiveness can be described as SE_{T} (dB)=SE_{A}+SE_{R}+SE_{M}. where SE_{A} and SE_{R} are related to absorption and reflection, respectively and given by [61]:

$$\begin{matrix}{SE}_{R} = - 10 log ( 1 - {\vert {S}_{11} \vert}^{2} ) & ( 5 ) \\ {SE}_{A} = - 10 log ( \frac{{\vert {S}_{21} \vert}^{2}}{1 - {\vert {S}_{11} \vert}^{2}} ) & ( 6 )\end{matrix}$$

SE_{M} (Multiple reflection effectiveness) can be ignored in this experiment while the shielding effectiveness is more than 10 dB. Additionally, it was observed that EMI SE has frequency-independent behavior. The average for EMI SE reported to be 20.46±0.40, 22.50±0.23, 25.18±0.45 and 29.49±0.69 dB for control, 2, 4 and 8 wt. %, respectively. Results revealed that inclusion only 4 wt. % MWCNTs resulted in a 20% increase in EMI SE, reaching 25 dB. It was reported SE_{T} close to 30 dB at X-band frequency consider as a sufficient level of shielding for many applications [62].

As the interaction between the nanofiber scaffolds and prepreg layers is very complex, a traditional classical laminate theory will not present the properties of the final enhanced composite. Therefore, a modified model has employed to analysis the properties. As mentioned before, the thickness of the nanofiber scaffold was set to be 10 μm to have optimum interdiffusion of epoxy during the cure process. It has been observed that the difference between the thickness of the control and enhanced composites is much smaller than the total thickness of deposited nanofiber scaffolds.

Moreover, there was no precise observation of separate electrospun nanofiber scaffolds in SEM images of enhanced composite, which suggests that due to great compatibility between electrospun nanofiber scaffolds and prepreg layers, the electrospun layer inter-diffuses and integrates with prepreg layers. As it is difficult to measure the thickness of inter-diffused nanofibers accurately, the approximation about ¼ of prepreg thickness was selected based on experiment results and SEM images. The new design of layers was done such that for 8 layers of prepreg, there should be 8 layers without the electrospun layer effect and 7 with electrospun effect.

To predict the mechanical properties of the enhanced layer with electrospun MWCNTs/epoxy nanofiber, the modified Halpin-Tsai model equations were applied. The selected Halpin-Tsai equation for randomly oriented discontinuous fibers to calculate the tensile modulus of the composites represented as follows [63]:

$${E}_{enhanced} = {E}_{prepreg} [ \frac{3}{8} ( \frac{1 + \frac{2 l}{d} {η}_{{LV}_{CNT}}}{1 - {η}_{{LV}_{CNT}}} ) + \frac{5}{8} ( \frac{1 + \frac{2 l}{d} {η}_{{TV}_{CNT}}}{1 - {η}_{{TV}_{CNT}}} ) ] \qquad ( 7 )$$

where E_{enhanced}, E_{prepreg}, and v_{CNT} are tensile modulus of enhanced layer, prepreg layer, and MWCNTs, respectively. The diameter and length are also defined by d and l, respectively.

The η parameter in equation 7 is represented by:

$$\begin{matrix}{η}_{L} = \frac{\frac{{E}_{CNT}}{{E}_{prepreg}} 1}{\frac{{E}_{CNT}}{{E}_{prepreg}} + 2 l / d} & ( 8 ) \\ {η}_{T} = \frac{\frac{{E}_{CNT}}{{E}_{EP}} - 1}{\frac{{E}_{CNT}}{{E}_{EP}} + 2} & ( 9 )\end{matrix}$$

For simplicity, the proportional assumption for shear modulus is used in the calculation for determination enhanced composite stiffness matrix. ABD stiffness parameters for composites were calculated using The Laminator software, and the parameters are defined according to Pelletier et al. [64].

From Halpin-Tsai model, tensile and bending modulus for control and enhanced CFRP have been determined and compared with experimental results. The theoretical and experimental values for tensile modulus (Eₓ) were determined to be 35.7 and 33.2 GPa for control and 43.0 and 39.6 GPa for enhanced composite, respectively. Similarly, the flexural modulus (E_{f}) was calculated for both control and enhanced composites, and values were reported to be 47 and 50 GPa for control and enhanced composites. The flexural modulus from the experiment was measured 43 and 48 GPa for control and enhanced composites. Results reveal ˜6.5 and 11% variation in theoretical and experimental values, respectively. Since there are some assumptions to simplify calculations, the present difference is still reasonable. Overall, the predicted values based on assumptions and model are in good agreement with experimental results, which show the discussions are reasonable.

The electrospun MWCNTs/epoxy nanofibers were successfully fabricated by a novel procedure making the thermoset epoxy resin spinnable. Nanofibers were fabricated by an optimized electrospinning process, resulted in the unidirectional formation of MWCNTs inside the nanofiber's structure. The size of the nanofibers and thickness of the electrospun scaffolds were adjusted without any interlayer deformation such that there was no issue in epoxy diffusion during composite fabrication. The mechanical properties, including interlaminar shear strength, fatigue, and BVID along with the thermal and electrical conductivity and EMI shielding of the fabricated composites, has been evaluated. Results revealed that by incorporating the electrospun nanofiber scaffold, the mechanical properties of the composite were considerably improved. Such that ILSS and fatigue performance, at 60% of ultimate static strength, increased by 21% and 47% by adding a 4 wt. % MWCNTs/epoxy nanofibers. About 19% and 11% increase were obtained for tensile and bending moduli at enhanced composite with 4 wt. % MWCNTs/epoxy. BVID energy was increased significantly by 45% at 4 wt. % MWCNTs compared to the control composite.

Further, shielding effectiveness of enhanced composite expressively increased by incorporation of highly conductive MWCNTs in CF structure using this method. An analytical model based on the experimental observation was established and employed to evaluate the enhancement of electrospun nanofiber scaffolds qualitatively. From the results, the effectiveness of the nanofiber scaffold was verified. Comparing all the results from mechanical, thermal and electrical properties, it was concluded that enhanced composites incorporating 4 wt. % MWCNTs/epoxy nanofibers have optimum properties, and therefore suitable for many high-performance applications.

This paper represents the process of fabrication and characterization of submicron carbon nanotubes (CNT)-epoxy nanocomposite filaments through an electrospinning process. Electrospinning of submicron epoxy filaments was made possible by partially curing of the epoxy through a thermal treatment process without the need for adding any plasticizers or thermoplastic binders. The diameter of these filaments can be tuned as low as 100 nm. By incorporating a low amount of CNT into epoxy, better structural, electrical, and thermal stability were achieved. The CNT fibers have been aligned inside the epoxy filaments due to the presence of the electrostatic field during the electrospinning process making these filaments suitable for many structural and sensing applications.

With the emergence of nanotechnology, researchers all over the world have been extensively devoting efforts to the preparation and discovery of new nanocomposites for various commercial composite applications [65-68]. The advantage of making these nanocomposites is to achieve better properties such as higher mechanical properties, thermal stability, and efficiency. According to the applications, the nanocomposites can be formed in different forms such as flakes, fibers and hybrids [69]. Recently multiple research has been conducted to extrude nanofilament made out of neat thermoplastic epoxy and nanocomposites [70]. Despite the research and progress on making composite-based nanosized filaments, the fabrication of a thermosetting nanocomposite is still a challenge. There are several limiting factors of making a continuous filament out of thermosetting epoxy, while the thermosetting polymers are limited to be extruded or stretched. Further having a uniform nanocomposite by adding nanomaterials to the thermosetting epoxy composite is still a challenge. In this paper, an elctrospinning based approach has been developed and tested to overcome the limits of fabricating a nanocomposite thermosetting epoxy filament with diameters in the range of nanoscale.

Compared to contemporary approaches for fabricating continuous nanofibers, electrospinning, which involves electrohydrodynamic phenomena, is widely acknowledged as the most versatile, effective and economically beneficial process [71]. This simple voltage-driven, electrostatic method only requires a pump, a high voltage power source, a collector and a solution reservoir tipped with a blunt needle [72]. Voltage, flow rate, needle-collector distance, viscosity, and type of solvents all represent key parameters in regulating the properties of the fibers created through electrospinning [73-76]. Different polymers have been examined in the past and have been shown compatible with electrospinning [77]. The uniform polymer nanofibers structures formed by electrospinning have been reported to have diameters ranging from 2 nm to several microns [77] and exhibit superior properties like the high surface area to volume ratio, flexibility in surface functionalities [78], inter/intra fibrous porosity, and extraordinary mechanical properties.

Thermosetting epoxy nanofibers are gaining tremendous popularity in many structural applications such as interlayer reinforcement in Carbon Fiber Reinforced Polymer (CFRP) composites. However, the production of these fibers at the nano-scale has never been achieved. Nanofibers synthesized via electrospinning of thermoplastic polymers such as Polyaniline (PANI), Polyvinylpyrrolidone (PVP), Polyvinyl alcohol (PVA), Polycaprolactone (PCL), etc [79] have been investigated in the development of thermoset-thermoplastic blending and core-sheath to fabricate such fibers (e.g. Polycaprolactone/Epoxy [80-81], Polyacrylonitrile/Epoxy [82]) to fabricate thermosetting filaments. Although, the presence of thermoplastic content in the resulting fibers can deteriorate their mechanical properties, especially under elevated thermal conditions. The removal of the sacrificial thermoplastic polymer after electrospinning, in a way that does not adversely influence the properties of resin, has represented a nearly impossible challenge. However, the innovative proposed approach is specifically developed to increase the spinnability of a widely used commercial thermosetting polymer to produce nanofibers that do not require destructive post-processing.

The overarching goal of this work is also to create fibers that could be electrospun along with nano reinforcements such as carbon nanotubes (CNTs) to produce nano hybrid fibril composites with enormous surface area as well as surface compatibility to be used with epoxy matrices in advanced diversified composite applications [83-87]. The degree of dispersion of the nanoparticles into the polymer matrix always influences the electro-mechanical characteristics of the final products [88-89]. Accordingly, CNT is one of the best candidates to make nanocomposites, due to its extraordinary mechanical properties [90-93]. Although CNT-based nanocomposites have been developed for many consumer and industrial products (such as Babolat tennis racquets, Baltic Yacht) [94-96], major limitations prevent large scale industrial manufacturing. Most of these nanocomposites are made by an extensive amount of CNT (not a cost-effective approach [97]). In addition, the lack of good CNT dispersion shows an unexpectedly large increase in the viscosity of epoxy resins [98]. Industry graded thermosetting epoxy nanocomposites with mechanically dispersed multi-walled carbon nanotubes have been studied previously [99-100]. Still, to date, controlled dispersion and agglomeration of CNTs for electrospinning have remained as a challenge mostly inside a thermosetting polymer matrix. This is due to the very strong Van der Waals binding energies related to the CNT aggregates, making clusters and nonuniform network inside the polymer. Thus, a method is needed to separate and sort the fibers to prevent clustering and make the uniform formation of CNT inside the structure. As it was previously reported, CNT polymer matrix has been developed using thermoplastic polymers through an electrospinning process to achieve unidirectional CNT structures while not adversely impacting the weight of the composite [101]. Despite multiple research on the fabrication of CNT composite nano fibers using thermoplastics polymers through electrospinning process, there is no significant research on using thermosetting polymers [101-103]. Due to high viscosity of thermosetting polymers, adding any nanomaterials such as carbon nanotubes can generate clusters in the structure, reducing the uniformity and making it less suitable for electrospinning. In this paper, we present a uniform dispersion of CNT in epoxy polymer that utilizes a multi-step mixing strategy. Here, based on forced extrusion of CNT-epoxy nanocomposite followed by electrospinning, unidirectional alignment of carbon nanotubes within electrospun epoxy nanofibers was achieved.

Solution parameters (e.g., polymer concentration, viscosity, conductivity, and surface tension) as well as process parameters (e.g., applied voltage, distance between the capillary tip and collector, and flow rate of the polymer solution) and ambient parameters (temperature and humidity) [104-107] have been carefully considered to optimize the sensitized nanofiber morphology. This work shows how to obtain CNT-based epoxy nanofibers to achieve greater mechanical characteristics in a simple and cost-effective way from an industrial perspective. Our method for CNT dispersion and nanofiber formation via electrospinning is easily scalable to higher manufacturing readiness levels.

A masterbatch of non-functionalized CNTs was used as nano-reinforcements for to be mixed with epoxy. The masterbatch consists of epoxy resin based on Bisphenol A (50-99 pbw. %), solvent (<15% volume) and carbon nanotubes (5 wt. %). The diameter of the nanotubes is in the range of 5-50 nm, with lengths in the 2-3 μm range. The nano-reinforcement via masterbatch was chosen to avoid CNTs suspension and to facilitate the dispersion process. Additionally, Dimethylformamide (DMF) and Triton X-100 were also effective at separating and suspending carbon nanotubes. Epikure 3234 (triethylenetetramine) was used as the curing agent and was supplied by Hexion specialty chemicals. Samples were prepared by mixing masterbatch and DMF (1:4 volume ratio) for 10 min using a magnetic stirrer, followed by probe sonication for 10 mins in intervals of 45 s and 30 s rest between cycles. Triton X-100 was then added into the mixture in the ratio 20:1 and was stirred for 10 min, followed by sonication in the same manner as before. Neat Epoxy was added in the same weight as masterbatch and stirred for 15 mins, followed by the same sonication method. The curing agent was then added to the mixture at a ratio of 15:1 and was allowed to stir at 50° C. for 2 hours in order to obtain a homogeneous solution. The mixture was degassed in a vacuum oven at room temperature for a minimum of 15 mins and was then allowed to rest for at least 24 hours before electrospinning. Prior to spinning, the prepared solution was added to a syringe with a needle gauge of 26 G. The pumping rate of the epoxy solution was adjusted to 0.5 mL/hr. The electrospinning voltage of 16 kV was applied between the needle and collector at room temperature and a needle tip/collector distance of 10 cm. At a critical voltage (between 12 to 16 kV), a jet of a solution emerged from the needle tip and was accumulated on the collector for 10 mins and stored in a vacuum oven at room temperature for 10 minutes. The process of making submicron CNT/epoxy filaments is shown in FIG. 17.

The quality of the fabricated composite was checked using a 785 nm Foster and Freeman microlaser Raman. Fiber formation and size were analyzed by field emission scanning electron microscopy (FESEM; JEOL 7800F, JEOL Japan). X-ray photoelectron spectroscopy (XPS) and Thermo Gravimetric Analysis (TGA) were conducted with a Omicron XPS/UPS system with Argus detector (ScientaOmicron, Germany) and a TA instrument—SDT Q600 TG thermal analyzer (TA, USA).

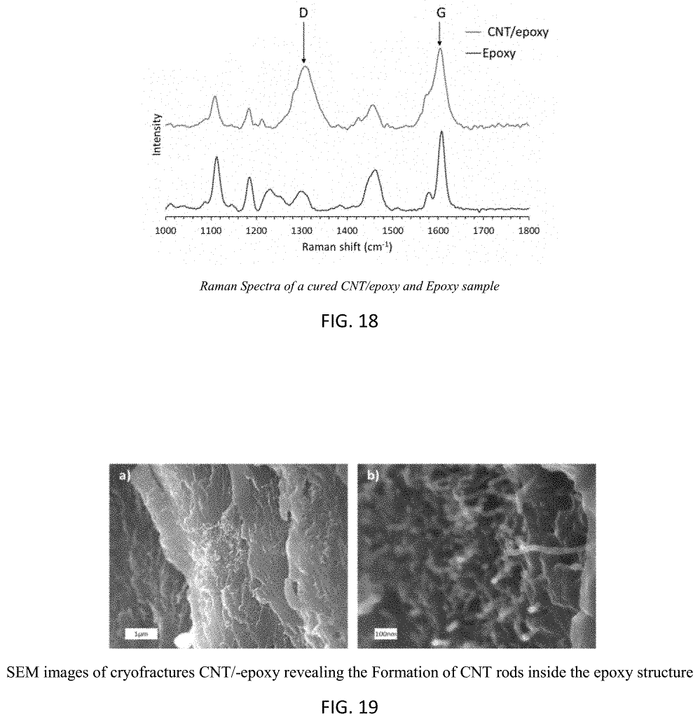

Morphology and uniformity of the fabricated epoxy composite have been analyzed. The CNT/epoxy batch was observed after preparation and showed no phase separation after 24 hours, and the solution was still dark black after adding the CNT. Further formation of CNT within the epoxy structure after curing was investigated using raman Spectroscopy and SEM. A comparison between the raman spectra of the epoxy alone and the CNT/epoxy is shown in FIG. 18. Raman spectroscopy results revealed that by adding CNT the peaks for D band go from 1315 to 1310, which is related primarily to sp3 bonds of carbon nanotubes, and the G band goes from 1607 to 1620 which is related to in-plane sheet sp2 hybridized carbon.

SEM analysis revealed that CNT is uniformly mixed within the epoxy. In addition, no significant change in the morphology of the epoxy was observed. This uniform distribution retains the properties of epoxy while improving its mechanical and electrical properties. The uniform formation of CNT is due to the presence of DMF, as a polar solvent, and adding plasticizers to prevent clustering. FIG. 19 shows SEM images of the resulting CNT/Epoxy samples, where the uniform formation of randomly sorted CNT inside the epoxy structure. It was also realized that by increasing the amount of CNT at first the mixture keeps its integrity and uniform structure, but by increasing the weight of CNT to 8%, clusters of CNT started to form in the mix. This phenomenon makes the solution made by higher CNT concentration in epoxy, less suitable for electrospinning. Due to this observation, all the samples for this manuscript have been made by 2% and 4% weight of CNT.

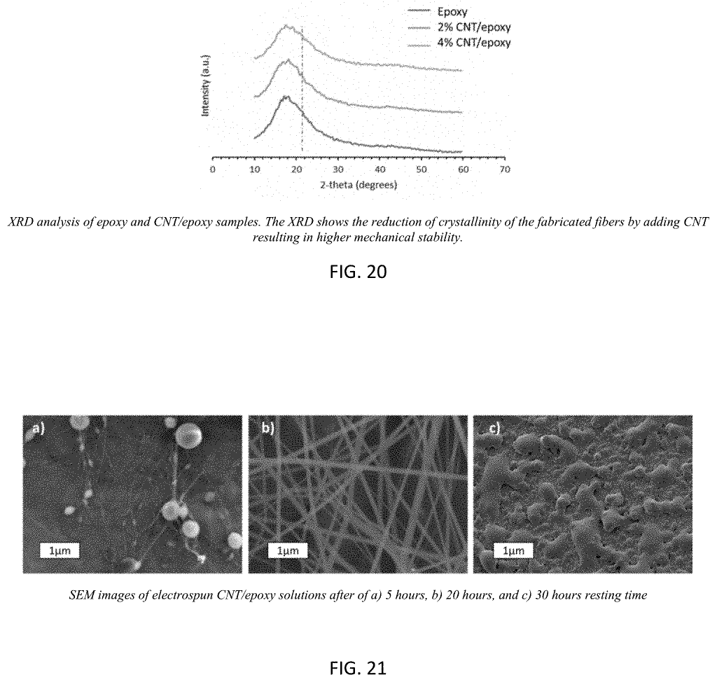

X-Ray Diffraction (XRD) investigates the microstructure evolution of pristine epoxy and epoxy composites with two different MWCNTs incorporation levels. XRD was performed with a 2θ scanning range from 10° to 60° and an arbitrary intensity unit. The XRD pattern of the neat epoxy shows a broad peak centered at around 2θ=17.5° as a result of the amorphous structure of the epoxy compounds. Adding 2% wt. of MWCNTs into epoxy resin, resulting in an upward shifting of this peak to around 2θ=18.5°, which is due to the grafting of the CNTs and its proper dispersion into epoxy composites. This also influences the microstructure of the epoxy composites by means of interfacial interactions between the CNTs and epoxy matrix [108]. Similarly, adding 4% wt. of CNTs into epoxy resin exhibits a higher value and narrow peak at 2θ=19.2°. The XRD pattern of 2% wt. CNT/epoxy composite shows a weak graphite-like (002) peak but 4% wt. CNT/epoxy grows a minor peak at around 2θ=220 (see FIG. 20), which is attributed to the characteristics of CNTs.

To determine the carbon crystals, the dimensions are expressed as stack height (L_{c} or L₀₀₂) and the average length (La) of a crystal. The Scherrer equation can calculate the crystallites without any distortion or strain in its network

$$Lc = \frac{K λ}{β ( 002 ) Cos θ ( 002 )} \qquad ( 10 )$$

Here λ is the wavelength of the X-ray beam (for Cu tube, λ=1.54 Å); K is a proportionality constant and for any unknown geometry of the crystallites. K is always assumed to be 0.89 for carbon. β₀₀₂ or L_{1/2} is the full width at the half-peak height of (002) plane and θ is the diffraction angle. The diffraction interplanar angles and the distance between the set of parallel atomic planes of a crystal lattice (dₕₖₗ—interplanar distance) can also be calculated by Bragg equation:

$$2 {d}_{hkl} = \frac{λ}{( 2 Sin θ )} \qquad ( 11 )$$

Table 4 represents the accumulative data of crystallographic parameters where MWCNTs with a full width at half maximum (FWHM) for plane (002), the interlayer distance (d002) are reported in the literature and Crystallographic parameters of CNT/epoxy composites are calculated using above mentioned equations. From the parameter analysis in Table 4, significant growth of the interlayer distance (d002) between graphene layers in the nanostructured composites has been identified. If we study the CNT behavior in polymeric composites, this interlayer distance growth happens due to the interaction of small molecules of epoxy resin between the layers of CNT structure [109-110]. Our proposed composite shows good CNT-polymeric matrix interaction resulting in an increase of the interlayer distance. So, the XRD patterns of the CNT/epoxy nanocomposites show that the CNT loading affects epoxy structure due to the intercalation of epoxy resin and CNT network making a proper interface between two different materials. However, a higher value of FWHM and smaller crystallite size (D) of the CNT/epoxy compare to the pure epoxy indicates the decrease of crystallographic structure in epoxy resin-nanocomposites providing more mechanical and thermal stability [109-110].

TABLE 4
Crystallographic parameters (2θ, L1/2,
d002) of CNT/epoxy nanostructured composites.

| Sample | 2θ (°) | FWHM (rad) | d₀₀₂ (Å) |
|---|---|---|---|
| MWCNTs [2] | 26.0/43 | 0.044 | 5.164 |
| Epoxy-2% wt. MWCNTs | 18.5/43 | 0.150 | 5.194 |
| Epoxy-4% wt. MWCNTs | 19.2/43 | 0.120 | 5.947 |

Rapid change of thermoset resin viscosity makes the fabrication of an electrospun filament challenging, while there is not an added thermoplastic to the solution. To achieve a spinnable viscosity, the epoxy mixture was adjusted using a partial curing method. The partial curing of the thermosetting epoxy helped to achieve spinnable viscosity to make it spinnable, but not completely cured. To check the process, samples were made with different resting times (5, 20, and 30 hrs) and the quality of the resulting fibers was investigated using SEM. FIG. 21 shows the change in fiber formation as a result of partial curing resting time. It was found that the lowest resting time (5 hrs) was not enough to ensure proper chemical bonding between the epoxy and hardener. Thus the viscosity is still in the range of 5 p. In contrast, higher rest time (30 hrs and more) almost fully cure the epoxy and results in high viscosities in the range of 500 p, preventing the solution to be spinnable. At lower viscosity (i.e. shorter rest time), the filament cannot form because during the electrospinning process, the surface tension of the solution and high electric field produce fragments by entangling the polymer chains. At higher viscosity (i.e. longer rest times) the mixture overcomes the surface tension of the solution and consequently, uniform fibers can be produced. By curing the epoxy solution for too long, higher ratios of entangles affect the uniformity of the fibers and lead to the production of large bids. Moreover, further increasing the curing time results in the solid components (fully cured) that completely damage the uniformity of the filament by hampering the solution flow rate through the needle tip and causing blockages. In this case the 20 hours of resting time is the optimum while the viscosity of the solution reached to 65 p makes it suitable for electrospinning.

Optimization of flow rate is also critical as higher flow rates can cause non-evaporation of the solvent and low stretching of the solution in the jet extruded between the collector and needle tip. These conditions ultimately increase the diameter of the nanofibers and the production of beads and ribbon-like structures [76]. In contrast, low flow rates under the critical point can cause failure in the formation of continuous nanofibers, affecting morphology. Here the flow rates of 0.1 to 1 mL/hr have been investigated. According to the viscosity of the solution, the 0.5 mL/hr flow rate made the best possible fibers. In higher pumping ratios (above 0.7 mL/hr) electro spraying starts so instead of having filaments, the uniform layer of CNT/epoxy is achieved, while in lower flow rates (less than 0.4 mL/hr) filaments are not extruding according to the lack of epoxy solution supply.

The distance between the needle and the metallic collector also plays a vital role. Several parameters must be optimized considering the deposition time of the polymer solution, the evaporation rate of the solvent, and whipping or instability interval [76, 111]. If the distance is kept relatively small, the potential for beaded and large-diameter nanofibers is increased [112]. In this case 10 cm distance is the optimum. Polymeric concentration with increased viscosity increases the chain entanglement among polymer chains and smooths the formation of continuous nanofibers. Yet, extreme viscosity can completely block the needle tip or start the formation of scattered beaded nanofibers with non-uniform diameters [113]. FIG. 21 shows the SEM images of the different electrospun samples that were cured at different times. As is shown here, 20 hours was the best resting time to make submicron filaments.

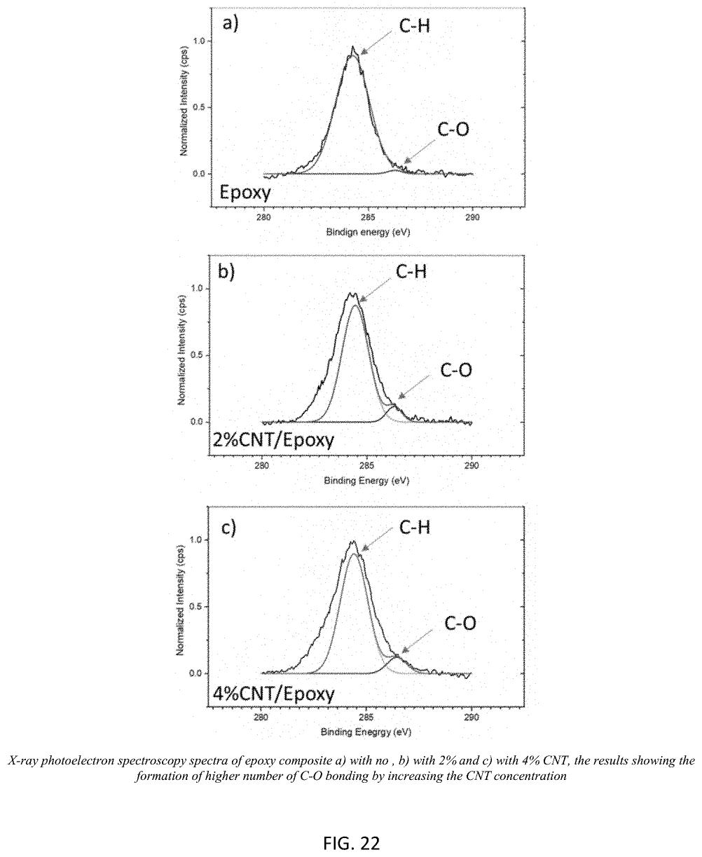

XPS: The XPS analysis of the CNT/epoxy filaments also has been conducted to check the crystallinity and the structure of the fibers. As it is shown in FIG. 22, the signature of the hydrocarbon peak (—CₓH_{y}—) has been identified at the binding energy of 284.6 eV which is related to the main structure of the epoxy. Further, by adding the CNT to the structure, the peak for alkoxy groups (C—O) starts to form with the binding energy of 286.2 eV [114-116]. As mentioned before in the XRD analysis, adding the CNT improves the crystallinity and stability of the structure. Here the analysis also demonstrates that by adding CNT the formation of alkoxy groups becomes more dominant, and this can result in having stronger bonding between polymer chains inside the structure. Adding more CNT renders in a higher count of the C—O bonding and formation of a more chemically and mechanically stable polymer [115, 117].

FIG. 22 show the cross-section and top view SEM image of fabricated submicron fibers respectively. As it is noted in FIG. 22a, the deposited nanocomposite structure provides a highly porous layer. The thickness of this layer is adjustable by setting spinning parameters and time of electrospinning. The actual size of the fibers was found to be in the range of 100-500 nm along with a uniform distribution. Further, a high magnification cross-section revealed that the CNT nanofibers were unidirectionally embedded inside the epoxy structure. This formation is well-suited for many applications spanning sensors, reinforcements, and different membranes [118-119]. This formation is due to the applied electric field throughout the electrospinning process. The high electric field moves the direction of the highly conductive CNT rods while the epoxy solution is still not fully cured. Later by extrusion of the filament, the outer shell of the filament begins to dry and retain the CNT formation in one direction. Another identification from SEM images is that by increasing the amount of CNT in epoxy mixture the fibers become thinner resulting in stiffer fibers. FIGS. 22b, c, and d show the top view of neat epoxy, 2 wt. % CNT/epoxy and 4 wt. % CNT/epoxy respectively. The identification of the images reveal that the fibers become thinner by increasing the amount of CNT. This is also proved before in the XRD section of this manuscript that the presence of CNT can improve the crystallinity of the epoxy mixture, results in the production of stronger fibers. The stronger fibers can be stretched more and make thinner filaments through the electrospinning process.

Thermo Gravimetric Analysis was conducted TG thermal analyzer, heating from ambient to 800° C. at a heating rate of 10° C./min to study the behavior of the materials in the functional environment they would be used in. The TGA samples were cut into small pieces to maintain sample weights between 5-20 mg. Epoxy samples started to decompose at around 360° C. and completely decomposed around 470° C. The 2 and 4 wt. % CNT/epoxy nanocomposite samples started to decompose at 359° C. and 356° C., respectively. In fact, by the addition of the CNT, the thermal conductivity of polymer increases following by elevation on heat diffusion and faster degradation. Although the degradation temperature starts earlier, the complete decomposition of samples with CNT is in higher temperatures. This is due to the improvement of crystallinity of the polymer after adding the CNT. Overall, CNT has little effect on the decomposition temperature of the epoxy and does not provide any thermal instability.

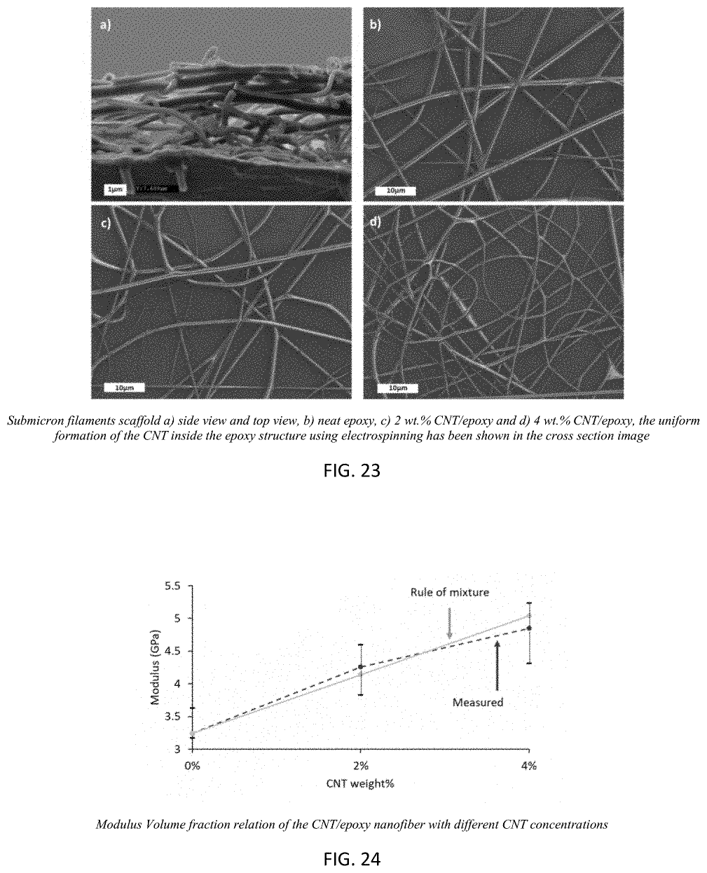

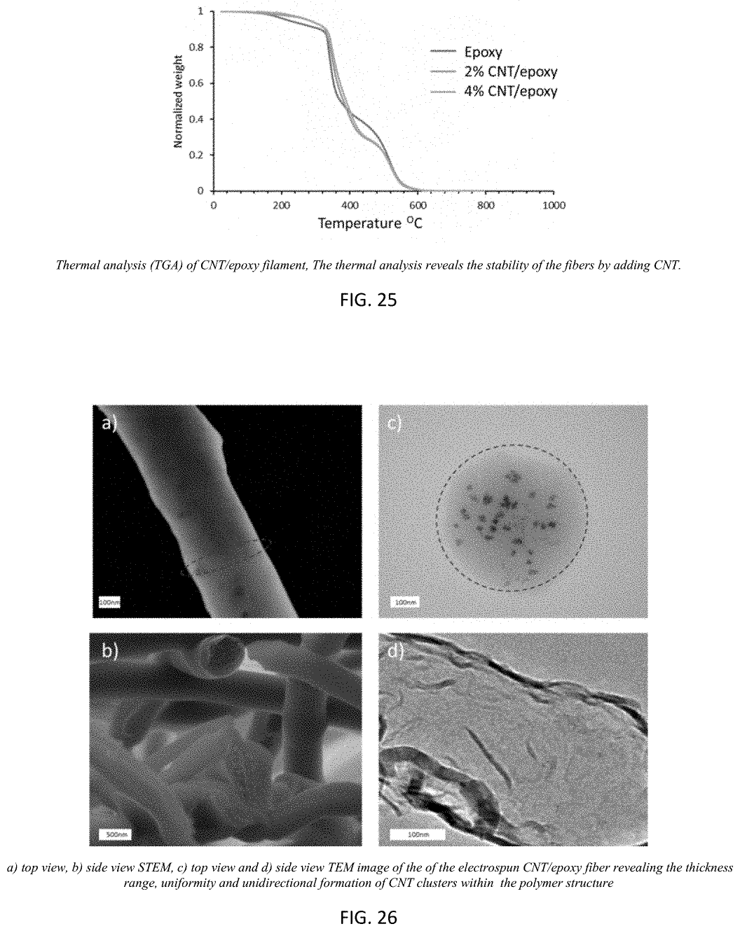

The surface area and mesopore structure of the electrospun epoxy and electrospun CNT/epoxy were characterized by Brunauer-Emmett-Teller (BET) and N2 adsorption isotherms using an adsorption instrument (Autosorb iQ2), respectfully. The nitrogen adsorption-desorption isotherms of electrospun epoxy and electrospun epoxy-MWCNTs materials are presented in FIG. 23. The nitrogen isotherm can be classified as a IV isotherm with a small hysteresis loop [120-121]. A small branching between 0.2 and 0.5 relative pressure indicates the mesoporous existence. The BET surface area of electrospun epoxy and 2 wt. % electrospun CNT/epoxy nanofiber was determined to be 233.19 m²/g and 291.34 m²/g, respectively. With increasing CNT % wt in the composites, the specific surface area also increased. The pore size calculation from Barret-Joyner-Halenda (BJH) analyses showed a distribution of mesopores/macropores in the range of 5-100 nm. The higher specific surface area provided adequate space for the epoxy resin to penetrate the electrospun layer, resulting in better interfacial bonding. Comparing the results of this section with the XRD results prove that the presence of CNT improves the polymerization of the epoxy and make a stronger structure. Thus, the filaments extruded in electrospinning process can achieve a lower cross-section area and providing higher porosity.

FIG. 24 reveals the improvement of the modulus of the fabricated fibers with the increase of CNT content measured using atomic force microscopy (Bruker Catalyst Atomic Force Microscope). As it is shown here, by adding more CNT to the fibers, the mechanical properties has been improved. The modulus has been increased linearly by increasing the carbon nanotube content. The measured modulus for neat epoxy is 3.24 GPa which is in the range of the reported value form the manufacturer while adding 2% and 4% of CNT has increased this value up to 4.2 GPa and 4.84 GPa, respectively. As it is shown here, the observed values are in confinement with the rule of mixture, validating the measured results. This can lead to a noticeable improvement of mechanical stability of the fabricated composites using these fibers as reinforcement layers, making them suitable for many applications such as aerospace and energy applications.

Uniformity of the developed fibers was also observed using STEM and TEM. FIG. 26(a) shows a STEM image of the side view of a filament and (b) reveals the cross-section of a filament. The STEM highlights the size of the fibers and the formation of a unidirectional CNT network indie the epoxy structure. Later the side view STEM of the fibers revealed that while CNT rods are made some clusters and some of these rods are bent, but the majority of the clusters and fibers are semi-aligned in the direction of the electric field. As noted in FIG. 26, the formation of CNT rods inside the filament has been investigated and subsequently the TEM imaging also proved the formation of CNT network. FIGS. 26(c) and (d) show a TEM image of a filament cross-section and side. Here the formation of CNT rods towards the direction of filament has been revealed. It is also observed that this formation is unidirectional due to the presence of an electric field and the electrical conductivity of the CNT network. This network exists while the length of the CNT is larger than the diameter of the filament the CNT rods in presence of an electric field must be aligned toward the length of the filaments.

Here, by electrospinning of a CNT/epoxy composite, submicron thermosetting filaments with embedded aligned CNT networks have been manufactured. Accordingly, the diameter of the fibers and thickness of the deposited layer could be precisely controlled using this method. Despite the fact that electrospinning a thermosetting polymer is still a challenge due to low viscosity of the solution and lack of plasticity, we were capable of making thermosetting polymers spinnable by developing a partial curing strategy through a thermal treatment process. Thus, spinnable viscosity and chemical bonding were properly achieved for electrospinning of the thermosetting polymer. Additionally, the very method helped to maintain the shape of the fiber; thus, multiple layers of the fibers were stacked uniformly without any interlayer deformation or diffusion. It was also observed that the addition of the CNT to the epoxy resin reduced the porosity of the fabricated filaments by up to 25 percent and increased the crystallinity of the polymer making it suitable for many composite applications. The obtained CNT/epoxy composites are promising for reinforcement of the structural composite parts and components in the aerospace, automotive, motorsports, and sporting goods due to their superior mechanical properties.

### REFERENCES

[1] W. Dong, H. C. Liu, S. J. Park, F. L. Jin, Fracture toughness improvement of epoxy resins with short carbon fibers, J. Ind. Eng. Chem. 20 (2014) 1220-1222. doi:10.1016/j.jiec.2013.06.053.
[2] K. Friedrich, A. A. Almajid, Manufacturing aspects of advanced polymer composites for automotive applications, Appl. Compos. Mater. 20 (2013) 107-128. doi:10.1007/s10443-012-9258-7.
[3] T. Yokozeki, T. Goto, T. Takahashi, D. Qian, S. Itou, Y. Hirano, Y. Ishida, M. Ishibashi, T. Ogasawara, Development and characterization of CFRP using a polyaniline-based conductive thermoset matrix, Compos. Sci. Technol. 117 (2015) 277-281. doi:10.1016/j.compscitech.2015.06.016.
[4] A. Pramanik, Developments in the non-traditional machining of particle reinforced metal matrix composites, Int. J. Mach. Tools Manuf 86 (2014) 44-61. doi:10.1016/j.ijmachtools.2014.07.003.
[5] T. Tanimoto, Carbon-fiber reinforced plastic passive composite damper by use of piezoelectric polymer/ceramic, Japanese J. Appl. Physics, Part 1 Regul. Pap. Short Notes Rev. Pap. 41 (2002) 7166-7169. doi:10.1143/JJAP.41.7166.
[6] A. Mikhalchan, M. Ridha, T. E. Tay, Carbon nanotube fibres for CFRP-hybrids with enhanced in-plane fracture behaviour, Mater. Des. 143 (2018) 112-119. doi:10.1016/j.matdes.2018.01.053.
[7] M. Zhao, L. Meng, L. Ma, L. Ma, X. Yang, Y. Huang, J. E. Ryu, A. Shankar, T. Li, C. Yan, Z. Guo, Layer-by-layer grafting CNTs onto carbon fibers surface for enhancing the interfacial properties of epoxy resin composites, Compos. Sci. Technol. 154 (2018) 28-36. doi:10.1016/j.compscitech.2017.11.002.
[8] K. Kim, Y. C. Jung, S. Y. Kim, B. J. Yang, J. Kim, Adhesion enhancement and damage protection for carbon fiber-reinforced polymer (CFRP) composites via silica particle coating, Compos. Part A Appl. Sci. Manuf. 109 (2018) 105-114. doi:10.1016/j.compositesa.2018.02.042.
[9] Y. Nadir, P. Nagarajan, M. Ameen, M. Arif M, Flexural stiffness and strength enhancement of horizontally glued laminated wood beams with GFRP and CFRP composite sheets, Constr. Build. Mater. 112 (2016) 547-555. doi:10.1016/j.conbuildmat.2016.02.133.
[10] M. Toozandehjani, Conventional and Advanced Composites in Aerospace Industry: Technologies Revisited, Am. J. Aerosp. Eng. 5 (2018) 9. doi:10.11648/j.ajae.20180501.12.
[11] S. Maegawa, Y. Morikawa, S. Hayakawa, F. Itoigawa, T. Nakamura, Mechanism for changes in cutting forces for down-milling of unidirectional carbon fiber reinforced polymer laminates: Modeling and experimentation, Int. J. Mach. Tools Manuf. 100 (2016) 7-13. doi:10.1016/j.ijmachtools.2015.10.003.
[12] J. Wen, Z. Xia, F. Choy, Damage detection of carbon fiber reinforced polymer composites via electrical resistance measurement, Compos. Part B Eng. 42 (2011) 77-86. doi:10.1016/j.compositesb.2010.08.005.
[13] Y. Hirano, T. Yamane, A. Todoroki, Through-thickness electric conductivity of toughened carbon-fibre-reinforced polymer laminates with resin-rich layers, Compos. Sci. Technol. 122 (2016) 67-72. doi:10.1016/j.compscitech.2015.11.018.
[14] U. K. Mallela, A. Upadhyay, Buckling of laminated composite stiffened panels subjected to in-plane shear: A parametric study, Thin-Walled Struct. 44 (2006) 354-361. doi:10.1016/j.tws.2006.03.008.
[15] J. H. S. Almeida, C. C. Angrizani, E. C. Botelho, S. C. Amico, Effect of fiber orientation on the shear behavior of glass fiber/epoxy composites, Mater. Des. 65 (2015) 789-795. doi:10.1016/j.matdes.2014.10.003.
[16] X. F. Wu, A. L. Yarin, Recent progress in interfacial toughening and damage self-healing of polymer composites based on electrospun and solution-blown nanofibers: An overview, J. Appl. Polym. Sci. 130 (2013) 2225-2237. doi:10.1002/app.39282.
[17] X. Shang, E. A. S. Marques, J. J. M. Machado, R. J. C. Carbas, D. Jiang, L. F. M. da Silva, Review on techniques to improve the strength of adhesive joints with composite adherends, Compos. Part B Eng. 177 (2019) 107363. doi:10.1016/j.compositesb.2019.107363.
[18] A. Pramanik, A. K. Basak, Y. Dong, P. K. Sarker, M. S. Uddin, G. Littlefair, A. R. Dixit, S. Chattopadhyaya, Joining of carbon fibre reinforced polymer (CFRP) composites and aluminium alloys—A review, Compos. Part A Appl. Sci. Manuf 101 (2017) 1-29. doi:10.1016/j.compositesa.2017.06.007.
[19] J. C. Del Real, Y. Ballesteros, R. Chamochin, J. Abenojar, L. Molisani, Influence of surface preparation on the fracture behavior of acrylic adhesive/CFRP composite joints, J. Adhes. 87 (2011) 366-381. doi:10.1080/00218464.2011.562114.
[20] R. Delmdahl, J. Brune, R. Pätzel, Ultraviolet Laser Cleaning of Carbon Fiber Composites, Powder Metall. Met. Ceram. 55 (2016) 1-4. doi:10.1007/s11106-016-9772-5.
[21] N. M. Chowdhury, W. K. Chiu, J. Wang, P. Chang, Experimental and finite element studies of bolted, bonded and hybrid step lap joints of thick carbon fibre/epoxy panels used in aircraft structures, Compos. Part B Eng. 100 (2016) 68-77. doi:10.1016/j.compositesb.2016.06.061.
[22] S. Aldajah, Y. Haik, Transverse strength enhancement of carbon fiber reinforced polymer composites by means of magnetically aligned carbon nanotubes, Mater. Des. 34 (2012) 379-383. doi:10.1016/j.matdes.2011.07.013.
[23] E. Bekyarova, E. T. Thostenson, A. Yu, M. E. Itkis, D. Fakhrutdinov, T. W. Chou, R. C. Haddon, Functionalized single-walled carbon nanotubes for carbon fiber-epoxy composites, J. Phys. Chem. C. 111 (2007) 17865-17871. doi:10.1021/jp071329a.
[24] H. Zhang, Y. Liu, M. Kuwata, E. Bilotti, T. Peijs, Improved fracture toughness and integrated damage sensing capability by spray coated CNTs on carbon fibre prepreg, Compos. Part A Appl. Sci. Manuf 70 (2015) 102-110. doi:10.1016/j.compositesa.2014.11.029.
[25] X. Yao, X. Gao, J. Jiang, C. Xu, C. Deng, J. Wang, Comparison of carbon nanotubes and graphene oxide coated carbon fiber for improving the interfacial properties of carbon fiber/epoxy composites, Compos. Part B Eng. 132 (2018) 170-177. doi:10.1016/j.compositesb.2017.09.012.
[26] A. K. Pathak, M. Borah, A. Gupta, T. Yokozeki, S. R. Dhakate, Improved mechanical properties of carbon fiber/graphene oxide-epoxy hybrid composites, Compos. Sci. Technol. 135 (2016) 28-38. doi:10.1016/j.compscitech.2016.09.007.
[27] X. Han, Y. Zhao, J. M. Sun, Y. Li, J. D. Zhang, Y. Hao, Effect of graphene oxide addition on the interlaminar shear property of carbon fiber-reinforced epoxy composites, Xinxing Tan Cailiao/New Carbon Mater. 32 (2017) 48-55. doi:10.1016/S1872-5805(17)60107-0.
[28] R. Baptista, A. Mend§ o, F. Rodrigues, C. G. Figueiredo-Pina, M. Guedes, R. Marat-Mendes, Effect of high graphite filler contents on the mechanical and tribological failure behavior of epoxy matrix composites, Theor. Appl. Fract. Mech. 85 (2016) 113-124. doi:10.1016/j.tafmec.2016.08.013.
[29] Y. Xu, S. Van Hoa, Mechanical properties of carbon fiber reinforced epoxy/clay nanocomposites, Compos. Sci. Technol. 68 (2008) 854-861. doi:10.1016/j.compscitech.2007.08.013.
[30] A. Dorigato, A. Pegoretti, M. Quaresimin, Thermo-mechanical characterization of epoxy/clay nanocomposites as matrices for carbon/nanoclay/epoxy laminates, Mater. Sci. Eng. A. 528 (2011) 6324-6333. doi:10.1016/j.msea.2011.04.042.
[31] V. C. S. Chandrasekaran, S. G. Advani, M. H. Santare, Role of processing on interlaminar shear strength enhancement of epoxy/glass fiber/multi-walled carbon nanotube hybrid composites, Carbon N. Y. 48 (2010) 3692-3699. doi:10.1016/j.carbon.2010.06.010.
[32] B. Wang, J. Yin, L. Wang, Y. Gao, Influence of Surfactant Modification on Structure and Properties of CNT Hybrid Multiscale Composites, (n.d.). doi:10.1002/mame.201300107.
[33] H. Yao, G. Zhou, W. Wang, M. Peng, Effect of polymer-grafted carbon nanofibers and nanotubes on the interlaminar shear strength and flexural strength of carbon fiber/epoxy multiscale composites, Compos. Struct. 195 (2018) 288-296. doi:10.1016/j.compstruct.2018.04.082.
[34] H. Conway, C. Gouldstone, Vertically aligned carbon nanotubes as interlaminar reinforcement in carbon fiber composite laminates, in: AIAA Scitech 2019 Forum, American Institute of Aeronautics and Astronautics Inc, AIAA, 2019. doi:10.2514/6.2019-1764.
[35] Y. Dzenis, D H Reneker—U.S. Pat. No. 6,265,333 U. 2001, Delamination resistant composite prepared by small diameter fiber reinforcement at ply interfaces, 1999. https://patents.google.com/patent/U.S. Pat. No. 6,265,333B1/en (accessed Oct. 10, 2019).
[36] N. Aliheidari, N. Aliahmad, M. Agarwal, H. Dalir, Electrospun Nanofibers for Label-Free Sensor Applications, Sensors. 19 (2019) 3587. doi: 10.3390/s19163587.
[37] T. R. Pozegic, S. G. King, M. Fotouhi, V. Stolojan, S. R. P. Silva, I. Hamerton, Delivering interlaminar reinforcement in composites through electrospun nanofibres, Adv. Manuf. Polym. Compos. Sci. 5 (2019) 155-171. doi:10.1080/20550340.2019.1665226.
[38] C. S. Reddy, A. Arinstein, R. Avrahami, E. Zussman, Fabrication of thermoset polymer nanofibers by co-electrospinning of uniform core-shell structures, J. Mater. Chem. 19 (2009) 7198-7201. doi:10.1039/b916185f.
[39] F. Zhang, Z. Zhang, Y. Liu, W. Cheng, Y. Huang, J. Leng, Thermosetting epoxy reinforced shape memory composite microfiber membranes: Fabrication, structure and properties, Compos. Part A Appl. Sci. Manuf 76 (2015) 54-61. doi:10.1016/j.compositesa.2015.05.004.
[40] Y. Yao, J. Wang, H. Lu, B. Xu, Y. Fu, Y. Liu, J. Leng, Thermosetting epoxy resin/thermoplastic system with combined shape memory and self-healing properties, Smart Mater. Struct. 25 (2015). doi:10.1088/0964-1726/25/1/015021.
[41] R. E. Neisiany, J. K. Y. Lee, S. N. Khorasani, S. Ramakrishna, Self-healing and interfacially toughened carbon fibre-epoxy composites based on electrospun core-shell nanofibres, J. Appl. Polym. Sci. 134 (2017). doi:10.1002/app.44956.
[42] A. Adeniyi, O. Agboola, E. R. Sadiku, M. O. Durowoju, P. A. Olubambi, A. Babul Reddy, I. D. Ibrahim, W. K. Kupolati, Thermoplastic-Thermoset Nanostructured Polymer Blends, in: Des. Appl. Nanostructured Polym. Blends Nanocomposite Syst., Elsevier Inc., 2016: pp. 15-38. doi:10.1016/B978-0-323-39408-6.00002-9.
[43] I. Martinez, M. D. Martin, A. Eceiza, P. Oyanguren, I. Mondragon, Phase separation in polysulfone-modified epoxy mixtures. Relationships between curing conditions, morphology and ultimate behavior, Polymer (Guildf). 41 (2000) 1027-1035. doi:10.1016/S0032-3861(99)00238-4.
[44] ASTM standard D 3039 “Tensile Properties of Polymer Matrix Composite Materials,” ASTM International, West Conshohocken, Pa., 2002.
[45] Sudarisman, I. J. Davies, The effect of processing parameters on the flexural properties of unidirectional carbon fibre-reinforced polymer (CFRP) composites, 2008. doi:10.1016/j.msea.2007.11.148.
[46] ASTM standard D790 “Flexural Properties of Unreinforced and Reinforced Plastics and Electrical Insulating Materials,” ASTM International, West Conshohocken, Pa., 2019.
[47] R. L. Zhang, B. Gao, W. T. Du, J. Zhang, H. Z. Cui, L. Liu, Q. H. Ma, C. G. Wang, F. H. Li, Enhanced mechanical properties of multiscale carbon fiber/epoxy composites by fiber surface treatment with graphene oxide/polyhedral oligomeric silsesquioxane, Compos. Part A Appl. Sci. Manuf 84 (2016) 455-463. doi:10.1016/j.compositesa.2016.02.021.
[48] D. Thaler, N. Aliheidari, A. Ameli, Mechanical, electrical, and piezoresistivity behaviors of additively manufactured acrylonitrile butadiene styrene/carbon nanotube nanocomposites, Smart Mater. Struct. 28 (2019) 084004. doi:10.1088/1361-665x/ab256e.
[49] S. Naeem, V. Baheti, V. Tunakova, J. Militky, D. Karthik, B. Tomkova, Development of porous and electrically conductive activated carbon web for effective EMI shielding applications, Carbon N. Y. 111 (2017) 439-447. doi:10.1016/j.carbon.2016.10.026.
[50] Z. Zeng, M. Chen, H. Jin, W. Li, X. Xue, L. Zhou, Y. Pei, H. Zhang, Z. Zhang, Thin and flexible multi-walled carbon nanotube/waterborne polyurethane composites with high-performance electromagnetic interference shielding, Carbon N. Y. 96 (2016) 768-777. doi:10.1016/j.carbon.2015.10.004.
[51] Q. Chen, Y. Zhao, Z. Zhou, A. Rahman, X. F. Wu, W. Wu, T. Xu, H. Fong, Fabrication and mechanical properties of hybrid multi-scale epoxy composites reinforced with conventional carbon fiber fabrics surface-attached with electrospun carbon nanofiber mats, Compos. Part B Eng. 44 (2013) 1-7. doi:10.1016/j.compositesb.2012.09.005.
[52] H. Park, C. Kong, Experimental study on barely visible impact damage and visible impact damage for repair of small aircraft composite structure, Aerosp. Sci. Technol. 29 (2013) 363-372. doi:10.1016/j.ast.2013.04.007.
[53] A. Katunin, K. Krukiewicz, R. Turczyn, P. Sul, M. Bilewicz, Electrically conductive carbon fibre-reinforced composite for aircraft lightning strike protection, in: IOP Conf. Ser. Mater. Sci. Eng., 2017. doi:10.1088/1757-899X/201/1/012008.
[54] J. Rehbein, P. Wierach, T. Gries, M. Wiedemann, Improved electrical conductivity of NCF-reinforced CFRP for higher damage resistance to lightning strike, Compos. Part A Appl. Sci. Manuf 100 (2017) 352-360. doi:10.1016/j.compositesa.2017.05.014.
[55] K. Molnár, G. Szebényi, B. Szolnoki, G. Marosi, L. M. Vas, A. Toldy, Enhanced conductivity composites for aircraft applications: Carbon nanotube inclusion both in epoxy matrix and in carbonized electrospun nanofibers, Polym. Adv. Technol. 25 (2014) 981-988. doi:10.1002/pat.3339.
[56] Z. Liu, G. Bai, Y. Huang, Y. Ma, F. Du, F. Li, T. Guo, Y. Chen, Reflection and absorption contributions to the electromagnetic interference shielding of single-walled carbon nanotube/polyurethane composites, Carbon N. Y. 45 (2007) 821-827. doi:10.1016/j.carbon.2006.11.020.
[57] C.-S. Zhang, Q.-Q. Ni, S.-Y. Fu, K. Kurashiki, Electromagnetic interference shielding effect of nanocomposites with carbon nanotube and shape memory polymer, (2007). doi:10.1016/j.compscitech.2007.05.011.
[58] M. H. Al-Saleh, U. Sundararaj, Electromagnetic interference shielding mechanisms of CNT/polymer composites, Carbon N. Y. 47 (2009) 1738-1746. doi:10.1016/j.carbon.2009.02.030.
[59] Y. Kazemi, Studying the Effects of Polymer Crystallization and Blending on Conductive Network Formation in CNT-Based Conductive Polymer Composites, 2018.
[60] Q. Q. Ni, M. Inoue, L. Zhang, Electromagnetic shielding property of CFRP composite laminates, ICCM Int. Conf. Compos. Mater. (2011). https://scholar.google.com/scholar?q=ELECTROMAGNETIC+SHIELDING+PROPERTY+OF+CFRP+COMPOSITE+LAMINATES&hl=en&as_sdt=0&as_vis=1&oi=scholart (accessed Oct. 28, 2019).
[61] M. G. Jang, S. C. Ryu, K. J. Juhn, S. K. Kim, W. N. Kim, Effects of carbon fiber modification with multiwall CNT on the electrical conductivity and EMI shielding effectiveness of polycarbonate/carbon fiber/CNT composites, J. Appl. Polym. Sci. 136 (2019). doi:10.1002/app.47302.
[62] S. Yang, K. Lozano, A. Lomeli, H. D. Foltz, R. Jones, Electromagnetic interference shielding effectiveness of carbon nanofiber/LCP composites, Compos. Part A Appl. Sci. Manuf 36 (2005) 691-697. doi:10.1016/j.compositesa.2004.07.009.
[63] A. R. Ghasemi, M. M. Mohammadi, M. Mohandes, The role of carbon nanofibers on thermo-mechanical properties of polymer matrix composites and their effect on reduction of residual stresses, Compos. Part B Eng. 77 (2015) 519-527.doi:10.1016/j.compositesb.2015.03.065.
[64] J. L. Pelletier, S. S. Vel, Multi-objective optimization of fiber reinforced composite laminates for strength, stiffness and minimal mass, Comput. Struct. 84 (2006) 2065-2080. doi:10.1016/j.compstruc.2006.06.001.
[65] Wang, Y.; He, J.; Chen, H.; Chen, J.; Zhu, R.; Ma, P.; Towers, A.; Lin, Y.; Gesquiere, A. J.; Wu, S. T. J. A. M., Ultrastable, highly luminescent organic-inorganic perovskite-polymer composite films. 2016, 28 (48), 10710-10717.
[66] Ling, T.; Wang, J. J.; Zhang, H.; Song, S. T.; Zhou, Y. Z.; Zhao, J.; Du, X. W. J. A. M., Freestanding ultrathin metallic nanosheets: Materials, synthesis, and applications. 2015, 27 (36), 5396-5402.
[67] Zhao, R.; Lu, X.; Wang, C. J. C. C., Electrospinning based all-nano composite materials: recent achievements and perspectives. 2018, 10, 140-150.
[68] Gajanan, K.; Tijare, S. J. M. T. P., Applications of nanomaterials. 2018, 5 (1), 1093-1096.
[69] Vijay Kumar, V.; Ramakrishna, S.; Kong Yoong, J. L.; Esmaeely Neisiany, R.; Surendran, S.; Balaganesan, G. J. M. D.; Communications, P., Electrospun nanofiber interleaving in fiber reinforced composites—Recent trends. 2019, 1 (1), e24.
[70] Demir, M. M.; Horzum, N.; Taşdemirci, A.; Turan, K.; Güden, M. J. A. a. m.; interfaces, Mechanical interlocking between porous electrospun polystyrene fibers and an epoxy matrix. 2014, 6 (24), 21901-21905.
[71] Reneker, D. H.; Yarin, A. L., Electrospinning jets and polymer nanofibers. Polymer 2008, 49 (10), 2387-2425.
[72] Wan, Y.-Q.; Guo, Q.; Pan, N. J. I. J. o. N. S.; Simulation, N., Thermo-electrohydrodynamic model for electrospinning process. 2004, 5 (1), 5-8.
[73] Theron, S. A.; Zussman, E.; Yarin, A. L., Experimental investigation of the governing parameters in the electrospinning of polymer solutions. Polymer 2004, 45 (6), 2017-2030.
[74] Aliheidari, N.; Aliahmad, N.; Agarwal, M.; Dalir, H. J. S., Electrospun Nanofibers for Label-Free Sensor Applications. 2019, 19 (16), 3587.
[75] Mitchell, G. R., Electrospinning: principles, practice and possibilities. Royal Society of Chemistry: 2015.
[76] Teo, W. E.; Ramakrishna, S. J. N., A review on electrospinning design and nanofibre assemblies. 2006, 17 (14), R89.
[77] Bhardwaj, N.; Kundu, S. C., Electrospinning: a fascinating fiber fabrication technique. Biotechnol Adv 2010, 28 (3), 325-47.
[78] Huang, Z.-M.; Zhang, Y. Z.; Kotaki, M.; Ramakrishna, S., A review on polymer nanofibers by electrospinning and their applications in nanocomposites. Composites Science and Technology 2003, 63 (15), 2223-2253.
[79] Megahed, A.; Zoalfakar, S. H.; Hassan, A. E.; Ali, A. A., A novel polystyrene/epoxy ultra-fine hybrid fabric by electrospinning. Polymers for Advanced Technologies 2018, 29 (1), 517-527.
[80] Zhang, F.; Zhang, Z.; Liu, Y.; Cheng, W.; Huang, Y.; Leng, J., Thermosetting epoxy reinforced shape memory composite microfiber membranes: Fabrication, structure and properties. Composites Part A: Applied Science and Manufacturing 2015, 76, 54-61.
[81] Yao, Y.; Wang, J.; Lu, H.; Xu, B.; Fu, Y.; Liu, Y.; Leng, J., Thermosetting epoxy resin/thermoplastic system with combined shape memory and self-healing properties. Smart Materials and Structures 2015, 25 (1), 015021.
[82] Neisiany, R. E.; Lee, J. K. Y.; Khorasani, S. N.; Ramakrishna, S., Self-healing and interfacially toughened carbon fibre-epoxy composites based on electrospun core-shell nanofibres. Journal of Applied Polymer Science 2017, 134 (31), 44956.
[83] Guo, Y.; Yang, X.; Ruan, K.; Kong, J.; Dong, M.; Zhang, J.; Gu, J.; Guo, Z., Reduced graphene oxide heterostructured silver nanoparticles significantly enhanced thermal conductivities in hot-pressed electrospun polyimide nanocomposites. ACS Applied Materials & Interfaces 2019.
[84] Wang, Y.; Yang, C.; Pei, Q.-X.; Zhang, Y., Some aspects of thermal transport across the interface between graphene and epoxy in nanocomposites. ACS applied materials & interfaces 2016, 8 (12), 8272-8279.
[85] Beckermann, G. W., Nanofiber interleaving veils for improving the performance of composite laminates. Reinforced Plastics 2017, 61 (5), 289-293.
[86] Johnsen, B.; Kinloch, A.; Mohammed, R.; Taylor, A.; Sprenger, S., Toughening mechanisms of nanoparticle-modified epoxy polymers. Polymer 2007, 48 (2), 530-541.
[87] Rosso, P.; Ye, L.; Friedrich, K.; Sprenger, S., A toughened epoxy resin by silica nanoparticle reinforcement. Journal of Applied Polymer Science 2006, 100 (3), 1849-1855.
[88] Wang, Q.; Wu, W.; Gong, Z.; Li, W., Flexural progressive failure of carbon/glass interlayer and intralayer hybrid composites. Materials 2018, 11 (4), 619.
[89] Kuwata, M.; Hogg, P., Interlaminar toughness of interleaved CFRP using non-woven veils: Part 1. Mode-I testing. Composites Part A: Applied Science and Manufacturing 2011, 42 (10), 1551-1559.
[90] Fiedler, B.; Gojny, F. H.; Wichmann, M. H.; Nolte, M. C.; Schulte, K., Fundamental aspects of nano-reinforced composites. Composites science and technology 2006, 66 (16), 3115-3125.
[91] Xie, X.-L.; Mai, Y.-W.; Zhou, X.-P., Dispersion and alignment of carbon nanotubes in polymer matrix: a review. Materials science and engineering: R: Reports 2005, 49 (4), 89-112.
[92] Gojny, F. H.; Wichmann, M. H.; Fiedler, B.; Schulte, K., Influence of different carbon nanotubes on the mechanical properties of epoxy matrix composites—a comparative study. Composites Science and Technology 2005, 65 (15-16), 2300-2313.
[93] Shaffer, M.; Sandler, J., Carbon nanotube/nanofibre polymer composites. in ‘Processing and properties of nanocomposites’ (ed.: Advani SG) World Scientific. New York 2006, 1-60.
[94] De Volder, M. F.; Tawfick, S. H.; Baughman, R. H.; Hart, A. J., Carbon nanotubes: present and future commercial applications. science 2013, 339 (6119), 535-539.
[95] Hussain, F.; Hojjati, M.; Okamoto, M.; Gorga, R. E., Polymer-matrix nanocomposites, processing, manufacturing, and application: an overview. Journal of composite materials 2006, 40 (17), 1511-1575.
[96] Aitken, R. J.; Chaudhry, M.; Boxall, A.; Hull, M., Manufacture and use of nanomaterials: current status in the UK and global trends. Occupational medicine 2006, 56 (5), 300-306.
[97] Ma, P.-C.; Siddiqui, N. A.; Marom, G.; Kim, J.-K., Dispersion and functionalization of carbon nanotubes for polymer-based nanocomposites: a review. Composites Part A: Applied Science and Manufacturing 2010, 41 (10), 1345-1367.
[98] Song, Y. S.; Youn, J. R., Influence of dispersion states of carbon nanotubes on physical properties of epoxy nanocomposites. Carbon 2005, 43 (7), 1378-1385.
[99] Giovannelli, A.; Di Maio, D.; Scarpa, F. J. M., Industrial-graded epoxy nanocomposites with mechanically dispersed multi-walled carbon nanotubes: static and damping properties. 2017, 10 (10), 1222.
[100] Özden-Yenigün, E.; Mencelo\check{g}lu, Y. Z.; Papila, M. J. A. a. m.; interfaces, MWCNTs/P (St-co-GMA) composite nanofibers of engineered interface chemistry for epoxy matrix nanocomposites. 2012, 4 (2), 777-784.
[101] Ko, F.; Gogotsi, Y.; Ali, A.; Naguib, N.; Ye, H.; Yang, G.; Li, C.; Willis, P., Electrospinning of continuous carbon nanotube-filled nanofiber yarns. Advanced materials 2003, 15 (14), 1161-1165.
[102] Sen, R.; Zhao, B.; Perea, D.; Itkis, M. E.; Hu, H.; Love, J.; Bekyarova, E.; Haddon, R. C., Preparation of single-walled carbon nanotube reinforced polystyrene and polyurethane nanofibers and membranes by electrospinning. Nano letters 2004, 4 (3), 459-464.
[103] Kausar, A., Polyamide-grafted-multi-walled carbon nanotube electrospun nanofibers/epoxy composites. Fibers and Polymers 2014, 15 (12), 2564-2571.
[104] Huang, Z.-M.; Zhang, Y.-Z.; Kotaki, M.; Ramakrishna, S., A review on polymer nanofibers by electrospinning and their applications in nanocomposites. Composites science and technology 2003, 63 (15), 2223-2253.
[105] Bhardwaj, N.; Kundu, S. C., Electrospinning: a fascinating fiber fabrication technique. Biotechnology advances 2010, 28 (3), 325-347.
[106] Thompson, C.; Chase, G. G.; Yarin, A.; Reneker, D., Effects of parameters on nanofiber diameter determined from electrospinning model. Polymer 2007, 48 (23), 6913-6922.
[107] Ali, A. A.; Eltabey, M.; Farouk, W.; Zoalfakar, S. H., Electrospun precursor carbon nanofibers optimization by using response surface methodology. Journal of Electrostatics 2014, 72 (6), 462-469.
[108] Liu, Z.; Bai, G.; Huang, Y.; Li, F.; Ma, Y.; Guo, T.; He, X.; Lin, X.; Gao, H.; Chen, Y., Microwave absorption of single-walled carbon nanotubes/soluble cross-linked polyurethane composites. The Journal of Physical Chemistry C 2007, 111 (37), 13696-13700.
[109] Francisco, W.; Ferreira, F. V.; Ferreira, E. V.; Cividanes, L. d. S.; Coutinho, A. d. R.; Thim, G. P., Functionalization of multi-walled carbon nanotube and mechanical property of epoxy-based nanocomposite. Journal of Aerospace Technology and Management 2015, 7 (3), 289-293.
[110] Moriche, R.; Prolongo, S.; Sánchez, M.; Jiménez-Suárez, A.; Sayagués, M.; Ureña, A., Morphological changes on graphene nanoplatelets induced during dispersion into an epoxy resin by different methods. Composites Part B: Engineering 2015, 72, 199-205.
[111] Matabola, K. P.; Moutloali, R. M., The influence of electrospinning parameters on the morphology and diameter of poly(vinyledene fluoride) nanofibers—effect of sodium chloride. Journal of Materials Science 2013, 48 (16), 5475-5482.
[112] Zhang, C.; Yuan, X.; Wu, L.; Han, Y.; Sheng, J., Study on morphology of electrospun poly(vinyl alcohol) mats. European Polymer Journal 2005, 41 (3), 423-432.
[113] Haider, S.; Al-Zeghayer, Y.; Ahmed Ali, F. A.; Haider, A.; Mahmood, A.; Al-Masry, W. A.; Imran, M.; Aijaz, M. O., Highly aligned narrow diameter chitosan electrospun nanofibers. Journal of Polymer Research 2013, 20 (4).
[114] Kettle, J.; Ding, Z.; Horie, M.; Smith, G. J. O. E., XPS analysis of the chemical degradation of PTB7 polymers for organic photovoltaics. 2016, 39, 222-228.
[115] Williams, T.; Yu, H.; Woo, R.; GRIGORIEV, M.; CHENG, D.; HICKS, R. F. J. A. M. P. L., Atmospheric Pressure Plasma as a Method for Improving Adhesive Bonding. 2014, 2631.
[116] Daneshkhah, A.; Vij, S.; Siegel, A. P.; Agarwal, M. J. C. E. J., Polyetherimide/carbon black composite sensors demonstrate selective detection of medium-chain aldehydes including nonanal. 2019, 123104.
[117] Zaldivar, R.; Nokes, J.; Steckel, G.; Kim, H.; Morgan, B. J. J. o. c. m., The effect of atmospheric plasma treatment on the chemistry, morphology and resultant bonding behavior of a pan-based carbon fiber-reinforced epoxy composite. 2010, 44 (2), 137-156.
[118] Naebe, M.; Lin, T.; Feng, L.; Dai, L.; Abramson, A.; Prakash, V.; Wang, X., Conducting polymer and polymer/cnt composite nanofibers by electrospinning. ACS Publications: 2009.
[119] He, X.-X.; Zheng, J.; Yu, G.-F.; You, M.-H.; Yu, M.; Ning, X.; Long, Y.-Z. J. T. J. o. P. C. C., Near-field electrospinning: progress and applications. 2017, 121 (16), 8663-8678.
[120] Dollimore, D.; Heal, G., An improved method for the calculation of pore size distribution from adsorption data. Journal of applied chemistry 1964, 14 (3), 109-114.
[121] Drake, L., Pore-size distribution in porous materials. Industrial & Engineering Chemistry 1949, 41 (4), 780-785.

While the disclosure has been illustrated and described in detail in the foregoing drawings and description, the same is to be considered as exemplary and not restrictive in character, it being understood that only illustrative embodiments thereof have been shown and described and that all changes and modifications that come within the spirit of the disclosure are desired to be protected.

All publications, patents, and patent applications referenced herein are hereby incorporated by reference in their entirety for all purposes as if each publication, patent, or patent application had been individually indicated to be incorporated by reference.

1-23. (canceled)

24. A composite article comprising:
a first material layer; and
a second material layer coupled to the first material layer to form an interface with the first material layer that includes a thermoset resin fiber having a plurality of carbon nanotubes,
wherein each of the plurality of carbon nanotubes is aligned with, and arranged parallel to, the thermoset resin fiber in a lengthwise direction,
wherein the interface is formed without a layer separate from the first and second material layers,
wherein one or more nanostructures associated with the first material layer penetrate the second material layer at the interface; and
wherein one or more nanostructures associated with the second material layer penetrate the first material layer at the interface.

25. The composite article of claim 24, wherein the plurality of carbon nanotubes are uniformly dispersed throughout at least 10% of an area of the interface.

26. The composite article of claim 24, wherein one or more of the plurality of carbon nanotubes are associated with the first material layer, and wherein the one or more of the plurality of carbon nanotubes penetrates into at least a portion of the second material layer.

27. The composite article of claim 26, wherein one or more of the plurality of carbon nanotubes are associated with the second material layer, and wherein the one or more of the plurality of carbon nanotubes associated with the second material layer penetrates into at least a portion of the first material layer.

28. The composite article of claim 24, wherein the thermoset resin fiber is an epoxy resin fiber.

29. The composite article of claim 24, wherein the thermoset resin is at least one resin selected from the following: epoxy amines, polymethylene diisocyanates (PMDI), polyurethane resins, polyimide resins, isocyanate resins, (meth)acrylic resins, phenolic resins, vinylic resins, styrenic resins, polyester resins, melamine resins, vinylester resins, maleimide resins, and mixtures thereof.

30. The composite article of claim 24, wherein each of the plurality of carbon nanotubes has a length of from 1400 nanometers to 1800 nanometers.

31. The composite article of claim 30, wherein each of the plurality of carbon nanotubes has a diameter of from 5 nanometers to 10 nanometers.

32. The composite article of claim 24, further comprising a third material layer, a fourth material layer, a fifth material layer, a sixth material layer, a seventh material layer, and an eighth material layer.

33. A method of producing a composite article, the method comprising:
processing a prepreg material including at least one polymer material and a plurality of carbon-containing reinforcement fibers;
preparing a nanocomposite solution including a thermoset resin and a plurality of carbon nanotubes; and
electrospinning the nanocomposite solution onto each layer of the prepreg material.

34. The method of claim 33, wherein electrospinning the nanocomposite solution onto each layer of the prepreg material includes depositing the nanocomposite solution between layers of the prepreg material.

35. The method of claim 34, further comprising dispersing the nanocomposite solution in the prepreg material such that the plurality of carbon nanotubes are aligned with one or more layers of the prepreg material and/or the carbon-containing reinforcement fibers.

36. The method of claim 33, further comprising dissipating a solvent of the nanocomposite solution.

37. The method of claim 33, wherein processing the prepreg material includes cutting the prepreg material into eight layers to form a laminate.

38. The method of claim 37, wherein cutting the prepreg material into eight layers to form the laminate includes arranging the eight layers in at least one 0/90/45/-45 stacking sequence.

39. The method of claim 33, wherein the thermoset resin includes an epoxy resin.

40. The method of claim 33, wherein the thermoset resin is at least one resin selected from the following: epoxy amines, polymethylene diisocyanates (PMDI), polyurethane resins, polyimide resins, isocyanate resins, (meth)acrylic resins, phenolic resins, vinylic resins, styrenic resins, polyester resins, melamine resins, vinylester resins, maleimide resins, and mixtures thereof.

41. The method of claim 33, wherein electrospinning the nanocomposite solution onto each layer of the prepreg material comprises producing the composite article.

42. The method of claim 41, wherein electrospinning the nanocomposite solution onto each layer of the prepreg material comprises:
forming a first material layer of the composite article; and
forming a second material layer of the composite article coupled to the first material layer to define an interface with the first material layer, and
wherein the interface is defined without a layer separate from the first and second material layers.

43. The method of claim 42, wherein:
one or more nanostructures associated with the first material layer penetrate the second material layer at the interface; and
one or more nanostructures associated with the second material layer penetrate the first material layer at the interface.
